(19) United States
(12) Patent Application Publication
(10) Pub. No.: US 2009/0096963 A1
(43) Pub. Date: Apr. 16, 2009

(54) CYCLIC POLYOLEFIN FILM, PROCESS FOR PRODUCING THE FILM, AND POLARIZING PLATE AND LIQUID CRYSTAL DISPLAY DEVICE USING THE SAME

(75) Inventors: Jun Takeda, Kanagawa (JP); Yutaka Nozoe, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/293,040

(22) PCT Filed: Mar. 15, 2007
(86) PCT No.: PCT/JP2007/055938

§ 371 Date: Sep. 15, 2008

(30) Foreign Application Priority Data
Mar. 15, 2006 (JP) 2006-071428
Feb. 7, 2007 (JP) 2007-028054

(51) Int. Cl. G02F 1/1335; B32B 27/00; C08K 5/435; C08K 5/41; C08K 5/20; C08L 23/00

(52) U.S. Cl. 349/96; 428/523; 264/216; 524/168; 524/167; 524/210; 524/570

(57) ABSTRACT

A cyclic polyolefin film, which comprises: a cyclic polyolefin resin; and at least one organic compound decreasing Rth(λ) and/or at least one organic compound decreasing Re(λ), wherein Rth(λ) represents a retardation value (nm) in a thickness-direction of the cyclic polyolefin film at a wavelength of λ nm, and Re(λ) represents an in-plane retardation value (nm) of the cyclic polyolefin film at a wavelength of λ nm, wherein the cyclic polyolefin film comprises the at least one organic compound in a content of from 0.01 to 30% by mass based on a solid component of the cyclic polyolefin resin.

### TECHNICAL FIELD

The present invention relates to a polarizing plate, a protective film for a polarizing plate, and a liquid crystal display device using the same. In particular, it relates to a cyclic polyolefin film to be used for them, and a process for producing the film.

### BACKGROUND ART

A polarizing plate is usually produced by sticking a protective film containing cellulose triacetate as a major component on each side of a polarizing film wherein iodine or a dichroic dye is adsorbed with an alignment on a polyvinyl alcohol. Cellulose triacetate has widely been used as a protective film for a polarizing plate as described above due to its advantages such as its strong toughness, high fire retardancy and high optical isotropy (low retardation value). A liquid crystal display device is constituted by a polarizing plate, a liquid crystal cell, and the like as described in JP-A-8-50206. However, the cellulose triacetate film absorbs or permeates moisture in such a large amount that it has involved the problems that its optically-compensatory performance will be changed and that it tends to deteriorate a polarizer.

Cyclic polyolefin films have attracted attentions as films which can dissolve the problems with the cellulose triacetate film of high hygroscopicity and high moisture permeability, and development of protective films for polarizing plates by thermal melt casting or solution casting have been conducted. Also, cyclic polyolefin films can develop high optical properties and, further, undergo less change in optical properties by change in temperature and humidity. Hence, development of a retardation membrane (also called “retardation film”) from them has been conducted (JP-A-2003-212927, JP-A-2004-126026, JP-A-2002-114827 and WO2004/049011).

### DISCLOSURE OF THE INVENTION

However, the cyclic polyolefin films have involved the problems that, since they can develop high optical properties, they undergo large changes in Re(λ) and Rth(λ) when stretch ratio changes only slightly, which makes it difficult to finely adjust optical properties of stretched films, and that it is difficult to obtain optical properties satisfying requirements for both Re(λ) and Rth(λ) at the same time by only a stretching step.

Also, there have been the problems that, while cellulose acetate films are hot stretched at from about 100 to about 150° C., the glass transition temperature of the cyclic polyolefin film is much lower than that and that the cyclic polyolefin film generates optical unevenness of film upon being stretched.

That is, while cyclic polyolefin films having so far been proposed satisfy conventional requirements in that they are excellent with respect to hygroscopicity and moisture permeability and undergo less change in optical properties by change in temperature and humidity, they are still insufficient to realize cyclic polyolefin films having intended and completely controlled Re(λ) and Rth(λ) and no optical unevenness. Thus, further development for solving these problems has been desired.

On the other hand, even with films having a small thickness, desired optical properties can be obtained by using a total of two films on respective sides of a liquid crystal cell as long as the film has Re(λ) and Rth(λ) which are low to some degrees. In this case, however, it costs much to use two films. Thus, it has also been desired to obtain desired Re(λ) and Rth(λ) by using only one film having a small thickness on one side of the liquid crystal cell.

The present invention has been made for satisfying these demands, and an object of the invention is to provide a cyclic polyolefin film which is excellent in hygroscopicity and moisture permeability, undergoes less change in optical properties by change in temperature and humidity, generates less optical unevenness and permits independent control of Re(λ) and Rth(λ). Another object of the invention is to provide a polarizing plate or a liquid crystal display device which can provide neutral black display with no image unevenness.

As a result of intensive investigations, the inventors have succeeded in obtaining intended optical properties upon production of a film by incorporating at least one retardation decreasing agent in a cyclic polyolefin resin and, as a result, have further found that a cyclic polyolefin film having surprisingly reduced optical unevenness can be obtained, thus having completed the invention based on the findings.

That is, the invention comprises the following constitution.

(1) A cyclic polyolefin film, which comprises:

a cyclic polyolefin resin; and

at least one organic compound decreasing Rth(λ), wherein Rth(λ) represents a retardation value (nm) in a thickness-direction of the cyclic polyolefin film at a wavelength of λ nm,

wherein the cyclic polyolefin film comprises the at least one organic compound in a content of from 0.01 to 30% by mass based on a solid component of the cyclic polyolefin resin.

(2) A cyclic polyolefin film, which comprises:

a cyclic polyolefin resin; and

at least one organic compound decreasing Re(λ), wherein Re(λ) represents an in-plane retardation value (nm) of the cyclic polyolefin film at a wavelength of λ nm,

wherein the cyclic polyolefin film comprises the at least one organic compound in a content of from 0.01 to 30% by mass based on a solid component of the cyclic polyolefin resin.

(3) A cyclic polyolefin film, which comprises:

a cyclic polyolefin resin;

at least one organic compound decreasing Rth(λ), wherein Rth(λ) represents a retardation value (nm) in a thickness-direction of the cyclic polyolefin film at a wavelength of λ nm; and

at least one organic compound decreasing Re(λ), wherein Re(λ) represents an in-plane retardation value (nm) of the cyclic polyolefin film at a wavelength of λ nm,

wherein the cyclic polyolefin film comprises at least one organic compound decreasing Rth(λ) and at least one organic compound decreasing Re(λ) in a content of from 0.01 to 30% by mass based on a solid component of the cyclic polyolefin resin, respectively.

(4) The cyclic polyolefin film as described in any of (1) to (3) above, which comprises at least one compound represented by formula (1) or (2) in a content of from 0.01 to 30% by mass based on the solid component of the cyclic polyolefin resin:

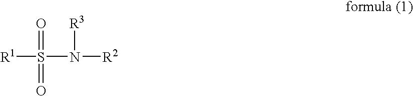

wherein R¹ represents an alkyl group or an aryl group;

R² and R³ each independently represents a hydrogen atom, an alkyl group or an aryl group, and a sum of carbon atoms of R¹, R² and R³ is 10 or more; and

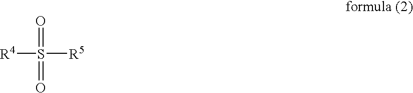

wherein R⁴ and R⁵ each independently represents an alkyl group or an aryl group, and a sum of carbon atoms of R⁴ and R⁵ is 10 or more.

(5) The cyclic polyolefin film as described in any of (1) to (3) above, which comprises at least one compound represented by formula (3), (4) or (5) in a content of from 0.01 to 30% by mass based on the solid component of the cyclic polyolefin resin:

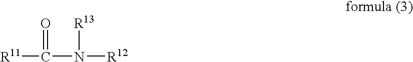

wherein R¹¹ represents an aryl group;

R¹² and R¹³ each independently represents an alkyl group or an aryl group, and at least one of R¹² and R¹³ is an aryl group; and

the alkyl group and the aryl group each optionally has a substituent;

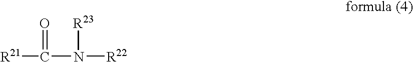

wherein R²¹, R²² and R²³ each independently represents an alkyl group which may have a substituent; and

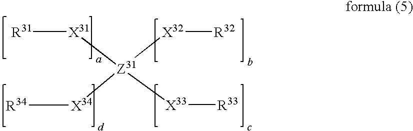

wherein R³¹, R³², R³³ and R³⁴ each independently represents a hydrogen atom, a substituted or unsubstituted aliphatic group or a substituted or unsubstituted aromatic group;

X³¹, X³², X³³ and X³⁴ each independently represents a divalent linking group formed by at least one member selected from the group consisting of a single bond, —CO—and —NR³⁵—, wherein R³⁵ represents a substituted or unsubstituted aliphatic group or a substituted or unsubstituted aromatic group;

a, b, c and d each independently represents an integer of 0 or more, and a+b+c+d is 2 or more; and

Z³¹ represents an organic group having a valency of (a+b+c+d) excluding a cyclic group.

(6) The cyclic polyolefin film as described in any of (1) to (5) above, which has a thickness of at least 30 μm.

(7) A process for producing a cyclic polyolefin film, which comprises:

dissolving a cyclic polyolefin film as described in any of (1) to (6) above in an organic solvent to prepare a dope;

casting the dope in a film form onto a support, so as to form a cast film;

releasing the cast film from the support, so as to form a released film; and

drying the released film, in this order,

wherein the process further comprises:

stretching the film before, during or after drying; and

winding up the film.

(8) A polarizing plate, which comprises:

two protective films; and

a polarizer provided between the two protective films,

wherein at least one of the two protective films is a cyclic polyolefin film as described in any of (1) to (6) above.

(9) A VA mode liquid crystal display device, which comprises:

two polarizing plates; and

a liquid crystal cell provided between the two polarizing plates,

wherein at lease one of the two polarizing plates is a polarizing plate as described in (8) above.

(10) The VA mode liquid crystal display device as described in (9) above,

wherein the polarizing plate according to claim 8 is used on a backlight side.

### BEST MODE FOR CARRYING OUT THE INVENTION

The invention will be described in detail below.

Additionally, in this specification, description of “(numeral 1)-(numeral 2)” or “(numeral 1) to (numeral 2)” means “equal to (numeral 1) or more and equal to (numeral 2) or less”.

First, the process for producing the cyclic polyolefin film of the invention and the cyclic polyolefin film will be described below.

The cyclic polyolefin film of the invention is produced in the form of containing at least a cyclic polyolefin resin.

### (Cyclic Polyolefin Resins)

In the invention, the cyclic polyolefin resin means a polymer resin having a cyclic polyolefin structure. In the invention, the cyclic polyolefin resin is also referred to as “cyclic polyolefin”.

Examples of the polymer resin to be used in the invention having the cyclic olefin structure include (1) norbornene series polymers, (2) polymers of a monocyclic olefin, (3) polymers of a cyclic conjugated diene, (4) vinyl-alicyclic hydrocarbon polymers, and hydrogenated products of (1) to (4). Polymer resins to be preferably used in the invention are addition (co)polymer cyclic polyolefins containing at least one kind of repeating unit represented by the following formula (II) and addition (co)polymer cyclic polyolefins further containing, as needed, at least one kind of repeating unit represented by the following formula (1). In addition, ring-opening (co)polymers containing at least one kind of cyclic repeating unit represented by the following formula (III).

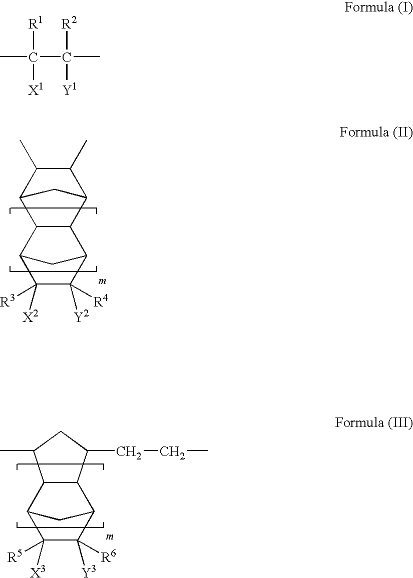

In the formulae, m represents an integer of from 0 to 4. R¹ to R⁶ each represents a hydrogen atom or a hydrocarbon group containing from 1 to 10 carbon atoms, X¹ to X³ and Y¹ to Y³ each represents a hydrogen atom, a hydrocarbon group containing from 1 to 10 carbon atoms, a halogen atom, a halogen atom-substituted hydrocarbon group containing from 1 to 10 carbon atoms, —(CH₂)ₙCOOR¹¹, —(CH₂)ₙOCOR¹², —(CH₂)ₙNCO—, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW or, when taken together, X¹ and Y¹, X² and Y², or X³ and Y³ constitute (—CO)₂O or (—CO)₂NR¹⁵. Additionally, R¹¹, R¹², R¹³, R¹⁴ and R¹⁵ each represents a hydrogen atom or a hydrocarbon group containing from 1 to 20 carbon atoms, Z represents a hydrocarbon group or a halogen-substituted hydrocarbon group, W represents SiR¹⁶pD₃₋ₚ (wherein R¹⁶ represents a hydrocarbon group containing from 1 to 10 carbon atoms, D represents a halogen atom, —OCOR¹⁶ or —OR¹⁶, and p represents an integer of from 0 to 3), and n represents an integer of from 0 to 10.

Retardation (Rth) of an optical film in a thickness-direction can be increased and development of retardation (Re) in an in-plane direction can be increased by introducing a functional group having a large polarizability into a substituent of X¹ to X³ and Y¹ to Y³.

As the norbornene series addition (co)polymers, those which are described in JP-A-10-7732, JP-T-2002-504184 (the term “JP-T” as used herein means a published Japanese translation of a PCT patent application), US 2004229157A1 or WO2004/070463A1 can be used. They can be obtained by addition polymerization of norbornene series polycyclic unsaturated compounds to each other. It is also possible to addition-polymerize the norbornene series polysyclic unsaturated compounds with conjugated dienes such as ethylene, propylene, butene, butadiene and isoprene; non-conjugated dienes such as ethylidenenorbornene; or linear diene compounds such as acrylonitrile, acrylic acid, methacrylic acid, maleic anhydride, acrylic ester, methacrylic ester, maleimide, vinyl acetate and vinyl chloride. As the norbornene series addition (co)polymers, commercially available ones can also be used. Specifically, there are products sold under the trade name of Apel by Mitsui Chemicals which include various grades different from each other in the glass transition temperature (Tg), such as APL8008T (Tg 70° C.), APL6013T (Tg 125° C.) and APL6015T (Tg 145° C.). Pellets of TOPAS8007, 6013 and 6015 are sold by Polyplastic Co., Ltd. Further, Appear 300 is sold by Ferrania.

As the hydrogenated products of norbornene series polymers, those which are prepared by addition polymerization or metathesis ring-opening polymerization of polycyclic unsaturated compounds and subsequent hydrogenation of the products, as disclosed in JP-A-1-240517, JP-A-7-196736, JP-A-60-26024, JP-A-62-19801, JP-A-2003-1159767 or JP-A-2004-309979, can be used. With the norbornene series polymers to be used in the invention, R⁵ and R⁶ each preferably is a hydrogen atom or —CH₃, X³ and Y³ each preferably is a hydrogen atom, Cl or —COOCH₃, and other groups are properly selected. As the norbornene series resins, commercially available ones may be used. Specifically, products sold under the trade names of Arton G and Arton F by JSR, or under the trade names of Zeonor ZF14, ZF16, Zeonex 250 and Zeonex 280 by Zeon Corporation can be used.

The mass-average molecular mass (Mw) of the cyclic polyolefin resin to be used in the invention measured by gel permeation chromatography (GPC) is preferably from 5,000 to 1,000,000, more preferably from 10,000 to 500,000, still more preferably from 50,000 to 300,000. Also, the molecular mass distribution (Mx/Mn; Mn being a number-average molecular mass measured by GPC) is preferably 10 or less, more preferably 5.0 or less, still more preferably 3.0 or less. The glass transition temperature (Tg; measured by DCS) is preferably from 50 to 350° C., more preferably from 80 to 330° C., still more preferably from 100 to 300° C.

### (Retardation Decreasing Agents)

The retardation decreasing agent to be used in the invention is preferably at least one member selected from those which are represented by the foregoing formula (1) or (2) or at least one member selected from those which are represented by the foregoing formula (3), (4) or (5). These retardation decreasing agents will be described in detail below.

First, compounds of the formulae (1) and (2) are described.

In the above formula (1), R¹ represents an alkyl group or an aryl group, R² and R³ each independently represents a hydrogen atom, an alkyl group or an aryl group, with the sum of carbon atoms of R¹, R² and R³ being particularly preferably 10 or more. In the formula (2), R⁴ and R⁵ each independently represents an alkyl group or an aryl group, with the sum of carbon atoms of R⁴ and R⁵ being 10 or more. The alkyl group and the aryl group may have a substituent. As the substituent, a fluorine atom, an alkyl group, an aryl group, an alkoxy group, a sulfon group and a sulfonamido group are preferred, with an alkyl group, an aryl group, an alkoxy group, a sulfon group and a sulfonamido group being particularly preferred. The alkyl group may be straight-chained, branched or cyclic. As the alkyl group, those which contain from 1 to 25 carbon atoms are preferred, those which contain from 6 to 25 carbon atoms are more preferred, and those which contain from 6 to 20 carbon atoms (e.g., methyl, ethyl, propyl, isopropyl, butyl, isobutyl, t-butyl, amyl, isoamyl, t-amyl, hexyl, cyclohexyl, heptyl, octyl, bicyclooctyl, nonyl, adamantly, decyl, t-octyl, undecyl, dodecyl, tridecyl, tetradecyl, pentadecyl, hexadecyl, heptadecyl, octadecyl, nonadecyl and didecyl) are particularly preferred. As the aryl group, those which contain from 6 to 30 carbon atoms are preferred, and those which contain from 6 to carbon atoms (e.g., phenyl, biphenyl, terphenyl, naphthyl, binaphthyl and triphenylphenyl) are particularly preferred. Preferred examples of the compounds represented by the formula (1) or (2) are shown below which, however, do not limit the invention in any way.

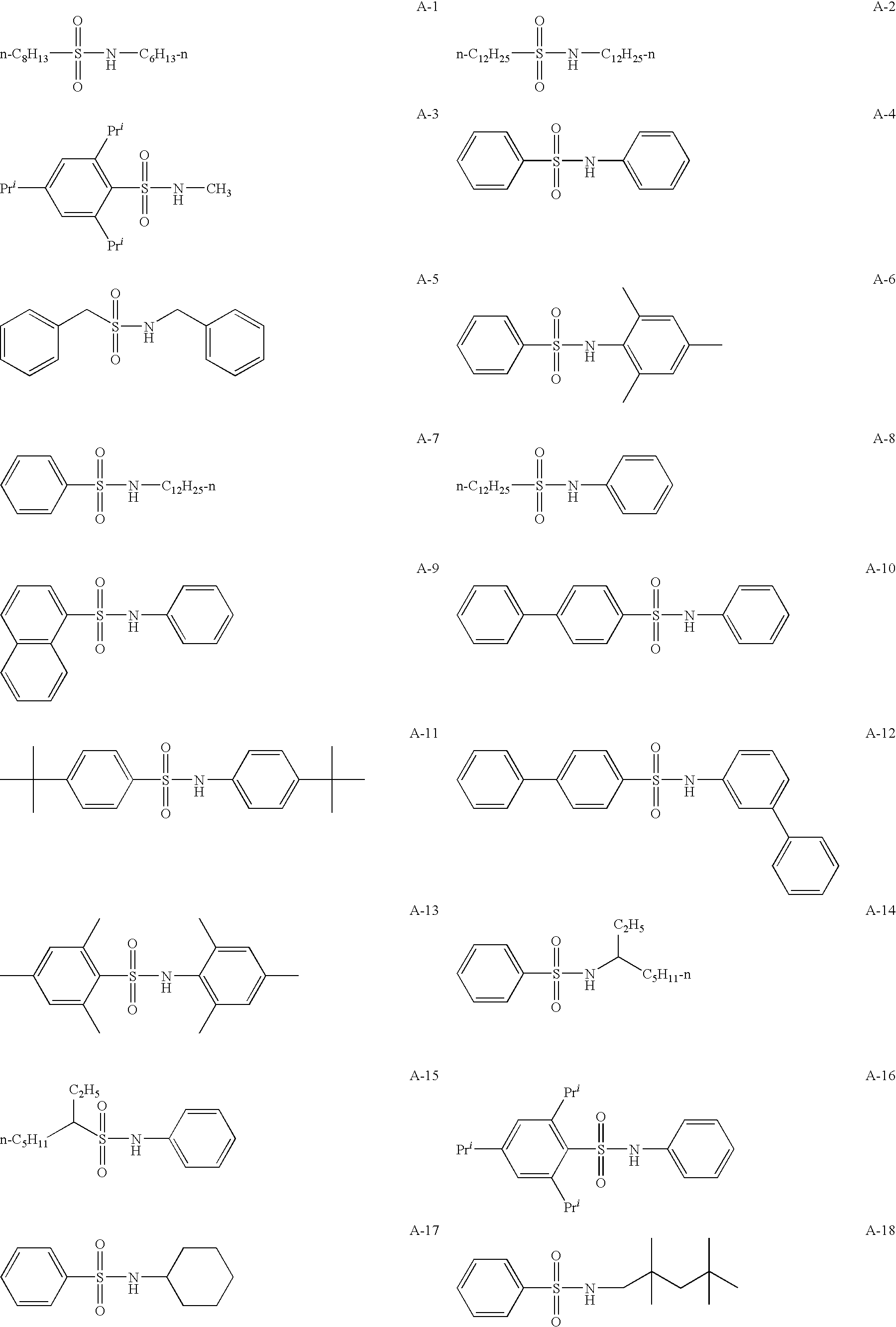

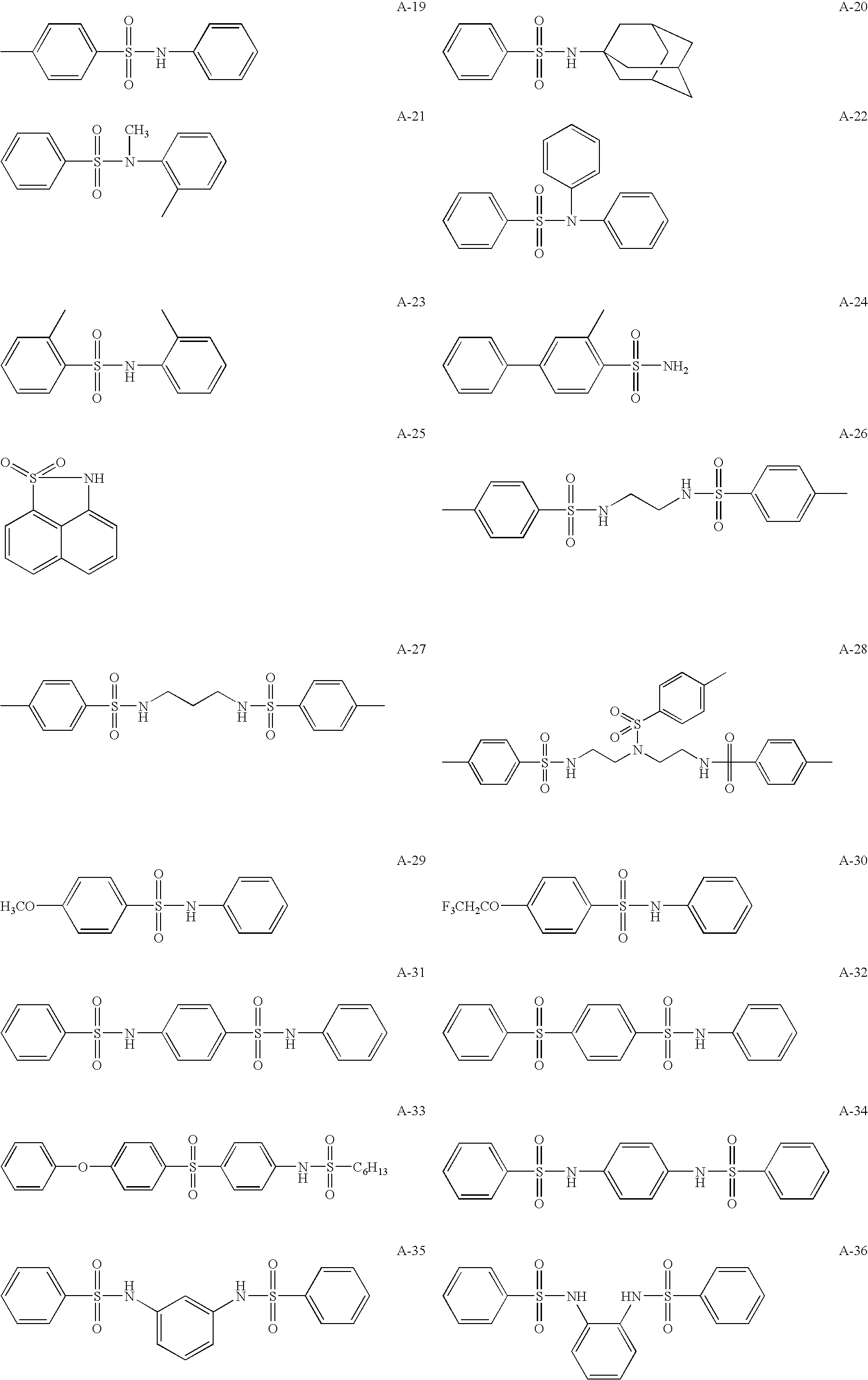

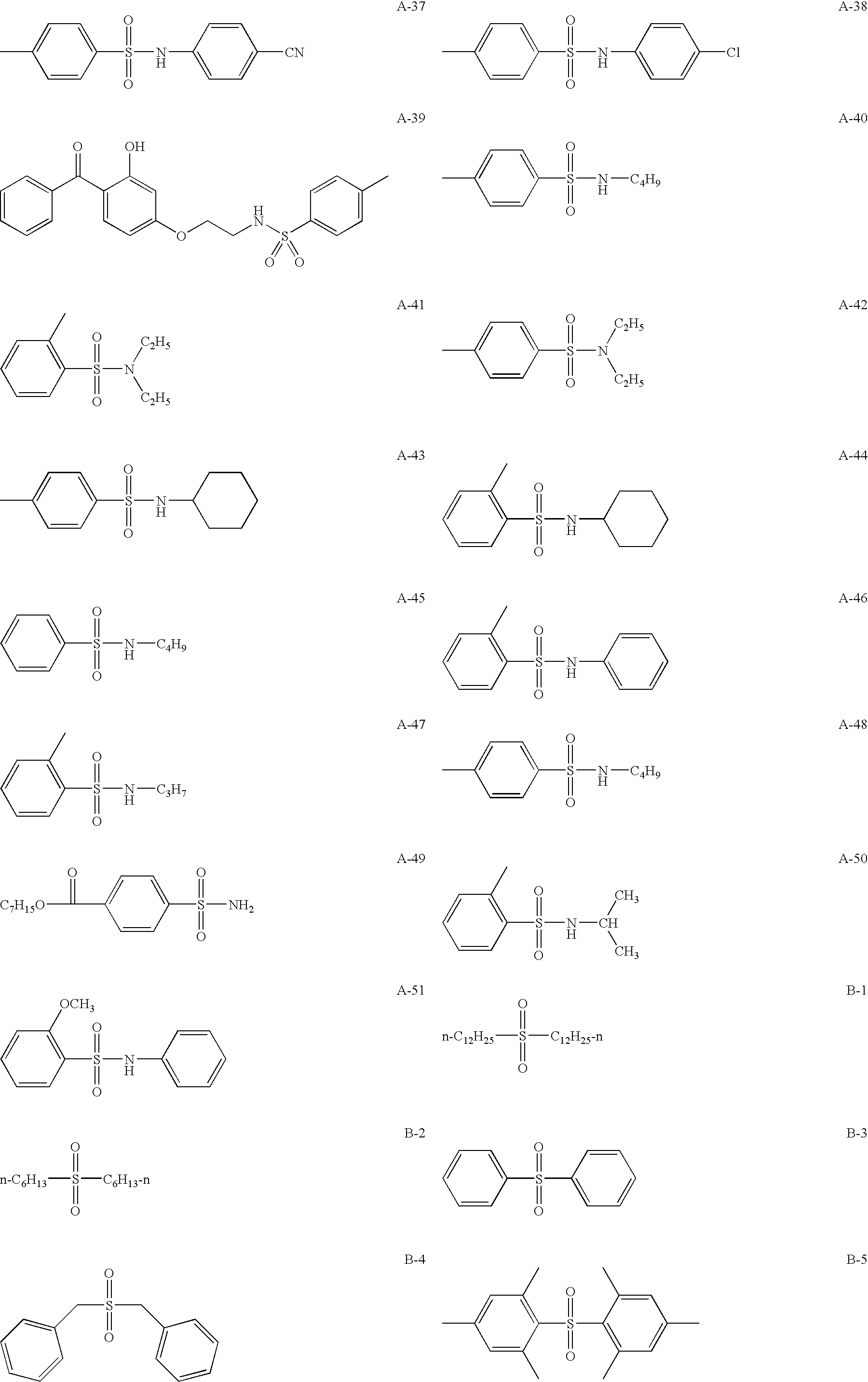

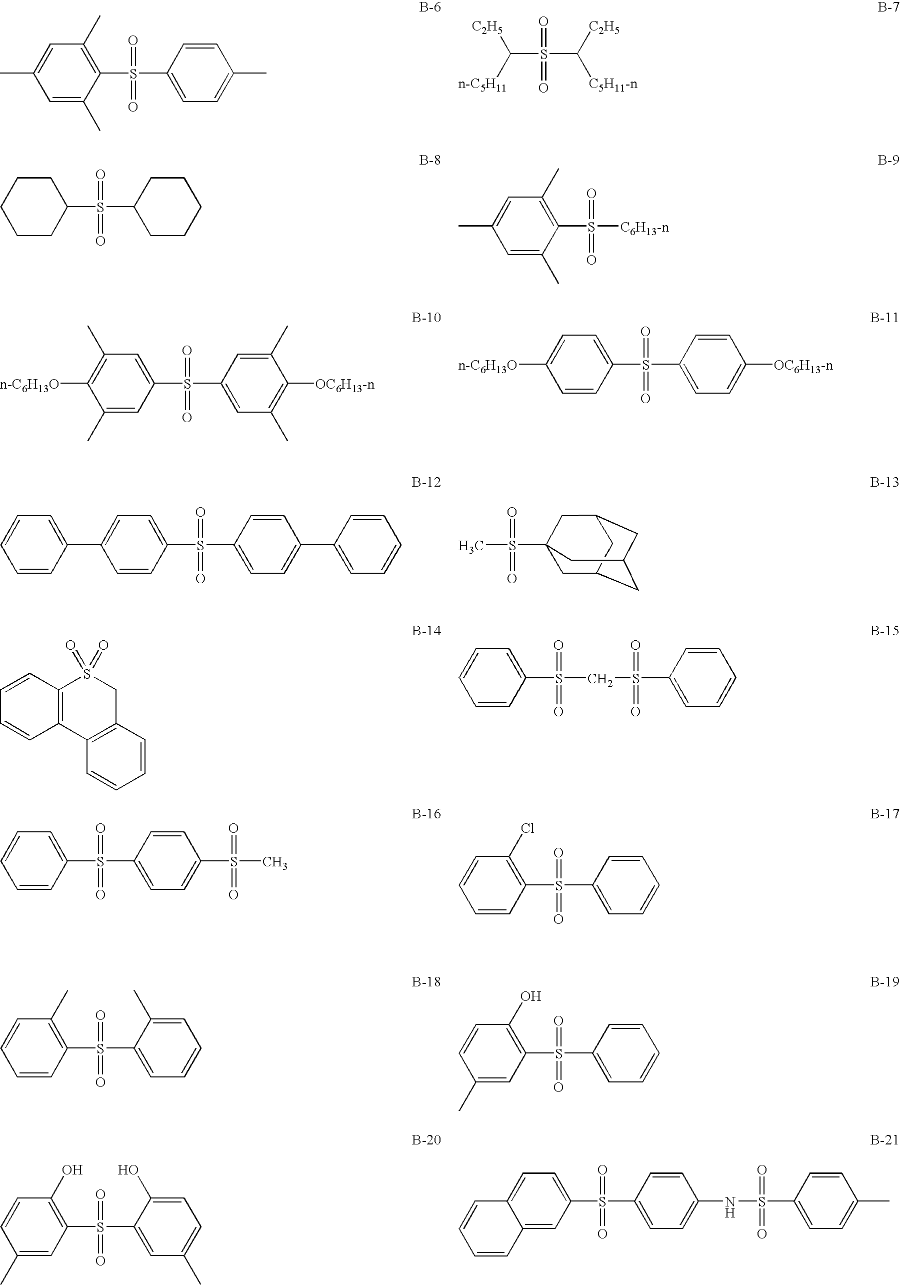

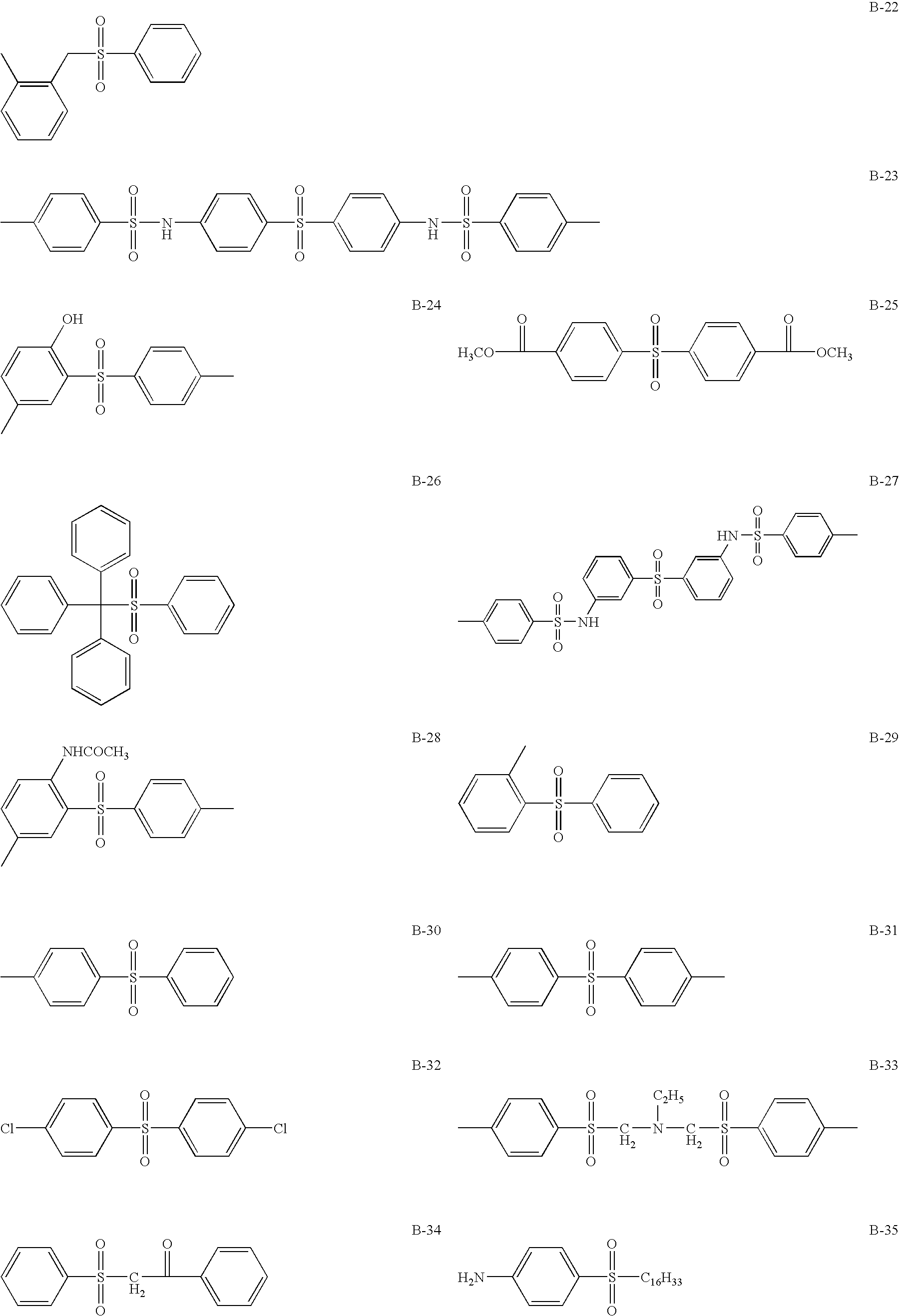

Next, compounds represented by the formula (3) will be described in detail below.

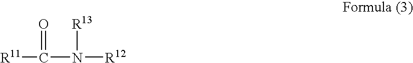

In the above formula (3), R¹¹ represents an aryl group, R¹² and R¹³ each independently represents an alkyl group or an aryl group, with at least one of R¹² and R¹³ being an aryl group. R¹³ may be an alkyl group or an aryl group, and is preferably an alkyl group. The alkyl group may be straight, branched or cyclic and contains preferably from 1 to 20 carbon atoms, more preferably from 1 to 15 carbon atoms, most preferably from 1 to 12 carbon atoms. The aryl group contains preferably from 6 to 36 carbon atoms, more preferably from 6 to 24 carbon atoms.

Next, compounds represented by the formula (4) will be described in detail below.

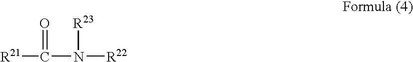

In the above formula (4), R²¹, R²² and R²³ each independently represents an alkyl group which may be straight, branched or cyclic. R²¹ is preferably a cyclic alkyl group, and at least one of R²² and R²³ is more preferably a cyclic alkyl group. The alkyl group contains preferably from 1 to 20 carbon atoms, more preferably from 1 to 15 carbon atoms, most preferably from 1 to 12 carbon atoms. As the cyclic alkyl group, a cyclohexyl group is particularly preferred.

The alkyl group and the aryl group in the above formulae (3) and (4) may have a substituent. As the substituent, a halogen atom (e.g., chlorine, bromine, fluorine or iodine), an alkyl group, an aryl group, an alkoxy group, an aryloxy group, an acyl group, an alkoxycarbonyl group, an aryloxycarbonyl group, an acyloxy group, a sulfonylamino group, a hydroxyl group, a cyano group, an amino group and an acylamino group are preferred, a halogen atom, an alkyl group, an aryl group, an alkoxy group, an aryloxy group, a sulfonylamino group and an acylamino group are more preferred, and an alkyl group, an aryl group, a sulfonylamino group and an acylamino group are particularly preferred.

Next, preferred examples of the compounds represented by the formulae (3) and (4) are shown below which, however, do not limit the invention in any way.

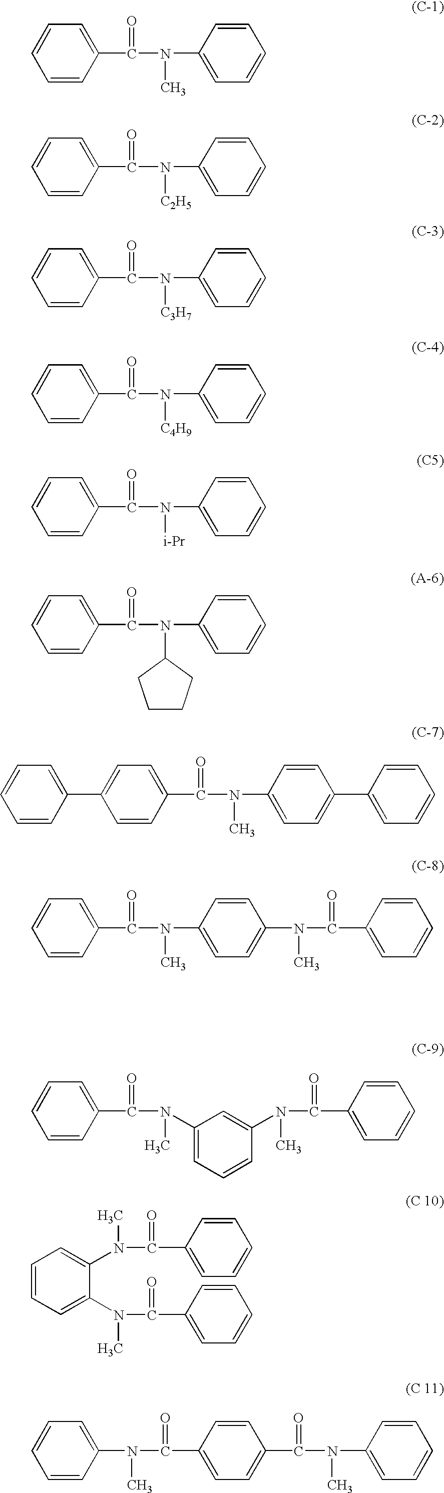

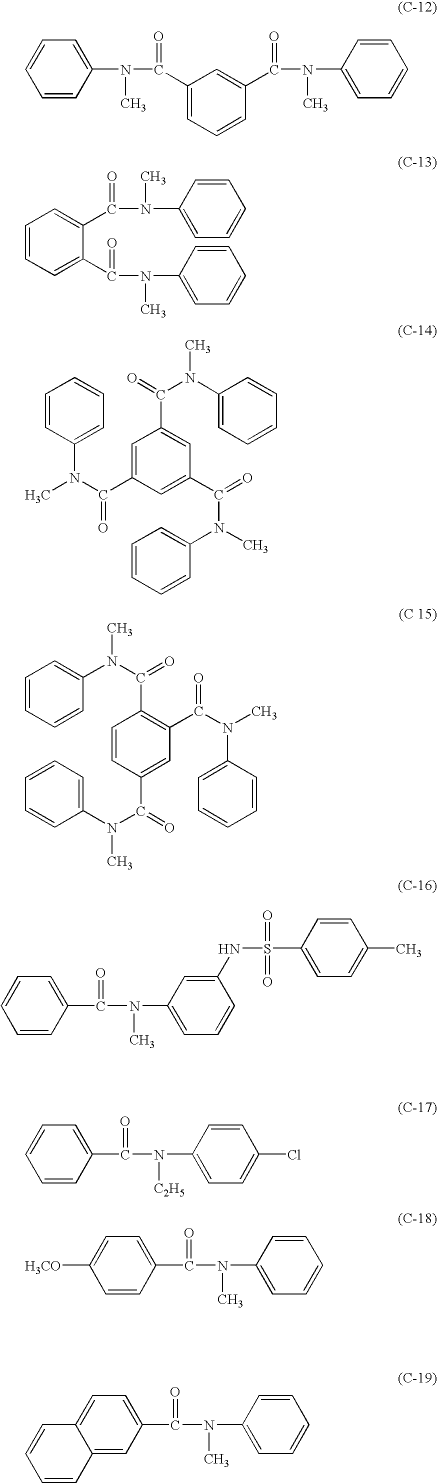

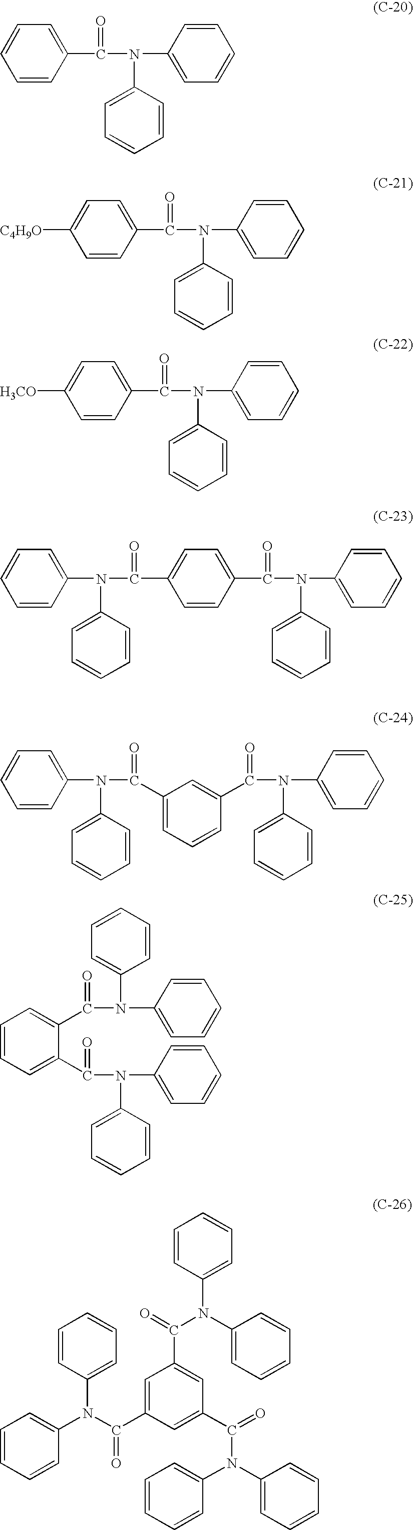

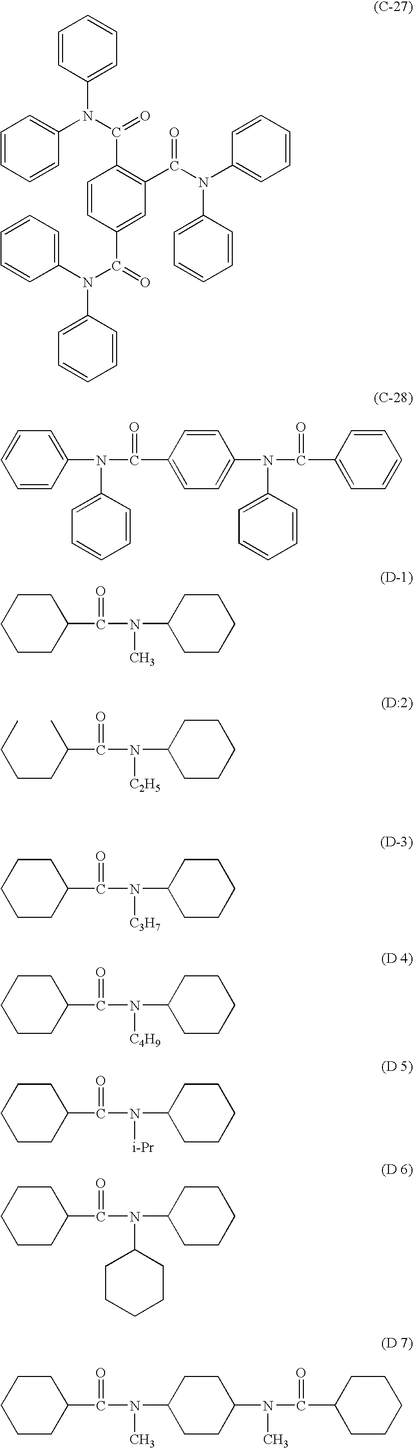

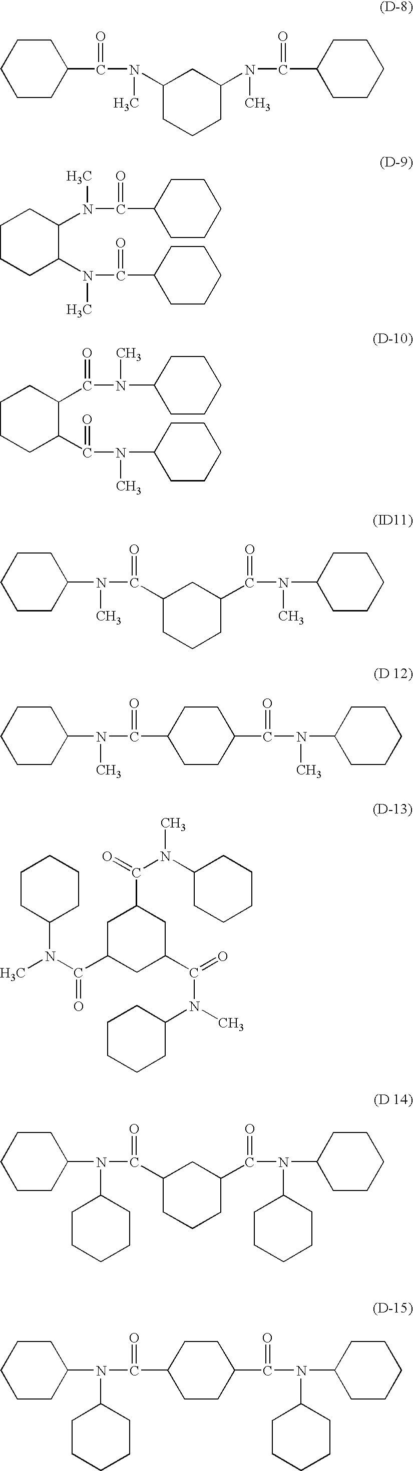

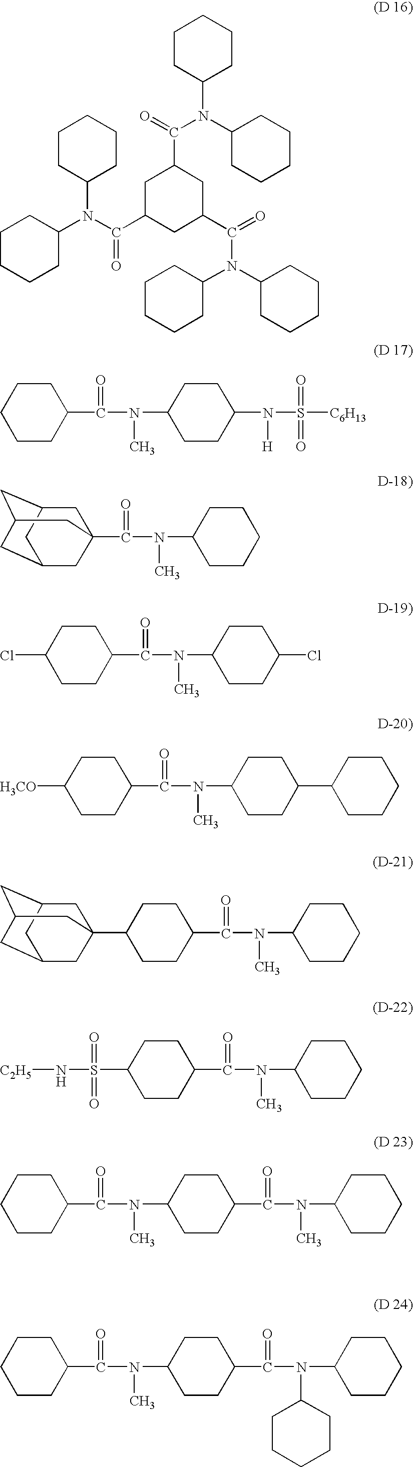

Next, compounds represented by the foregoing formula (5) will be described below.

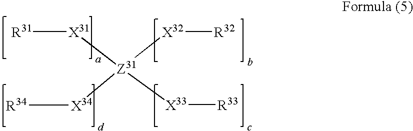

In the above formula (5), R³¹, R³², R³³ and R³⁴ each represents a hydrogen atom, a substituted or unsubstituted aliphatic group or a substituted or unsubstituted aromatic group, with an aliphatic group being preferred. The aliphatic group may be straight, branched or cyclic, and is more preferably cyclic. As the substituents which the aliphatic group and the aromatic group may have, there can be illustrated substituents T to be described hereinafter. However, unsubstituted aliphatic and aromatic groups are preferred

X³¹, X³², X³³ and X³⁴ each represents a divalent linking group formed by one or more members selected from the group consisting of a single bond, —CO— and NR³⁵ (wherein R³⁵ represents a substituted or unsubstituted aliphatic group or a substituted or unsubstituted aromatic group, with unsubstituted ones and/or an aliphatic group being more preferred). The combination of X³¹, X³², X³³ and X³⁴ is not particularly limited, but is preferably selected from —CO— and —NR³⁵—. a, b, c and d each represents an integer of 0 or more, preferably 0 or 1, a+b+C+d is 2 or more, preferably from 2 to 8, more preferably from 2 to 6, still more preferably from 2 to 4, and Z³¹ represents an organic group (excluding a cyclic group) having a valency of (a+b+c+d). The valency of Z³¹ is preferably from 2 to 8, more preferably from 2 to 6, still more preferably from 2 to 4, most preferably 2 or 3. The term “organic group” as used herein means a group comprising an organic compound.

As compounds represented by the above formula (5), those compounds which are represented by the following formula (5-1) are preferred compounds.

R³¹¹—X³¹¹—Z³¹¹—X³¹²—R³¹² Formula (5-1)

In the above formula (5-1), R³¹¹ and R³¹² each represents a substituted or unsubstituted aliphatic group or a substituted or unsubstituted aromatic group, preferably an aliphatic group. The aliphatic group may be straight, branched or cyclic, and is preferably cyclic. As the substituents which the aliphatic group and the aromatic group may have, there can be illustrated substituents T to be described hereinafter. However, unsubstituted aliphatic and aromatic groups are preferred. X³¹¹ and X³¹² each independently represents —CONR³¹³— or —NR³¹⁴CO— (wherein R³¹³ and R³¹⁴ each represents a substituted or unsubstituted aliphatic group or a substituted or unsubstituted aromatic group, with unsubstituted ones and/or an aliphatic group being more preferred). Z³¹¹ represents a divalent organic group (excluding a cyclic group) formed by one or more members selected from among —O—, —S—, —SO—, —SO₂—, —CO—, —NR³¹⁵— (wherein R³¹⁵ represents a substituted or unsubstituted aliphatic group or a substituted or unsubstituted aromatic group, with unsubstituted ones and/or an aliphatic group being more preferred), an alkylene group and an arylene group. The combination of Z³¹¹ is not particularly limited, but is preferably selected from among —O—, —S—, —NR³¹⁵— and an alkylene group, more preferably from among —O—, —S— and an alkylene group, most preferably from among —O—, —S— and an alkylene group.

Of the compounds represented by the above formula (5-1), compounds represented by the following formulae (5-2) to (5-4) are preferred compounds.

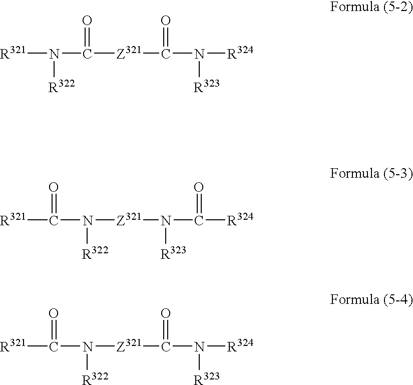

In the above formulae (5-2) to (5-4), R³²¹, R³²², R³²³ and R³²⁴ each each represents a hydrogen atom, a substituted or unsubstituted aliphatic group or a substituted or unsubstituted aromatic group, with an aliphatic group being preferred. The aliphatic group may be straight, branched or cyclic, and is more preferably cyclic. As the substituents which the aliphatic group and the aromatic group may have, there can be illustrated substituents T to be described hereinafter. However, unsubstituted aliphatic and aromatic groups are preferred. Z³²¹ represents a divalent linking group formed by one or more members selected from among —O—, —S—, —SO—, —SO₂—, —CO—, —NR³²⁵— (wherein R³²⁵ represents a substituted or unsubstituted aliphatic group or a substituted or unsubstituted aromatic group, with unsubstituted ones and/or an aliphatic group being more preferred), an alkylene group and an arylene group. The combination of Z³²¹ is not particularly limited, but is preferably selected from among —O—, —S—, —NR³²⁵— and an alkylene group, more preferably from among —O—, —S— and an alkylene group, most preferably from among —O—, —S— and an alkylene group.

The substituted or unsubstituted aliphatic group will be described below.

The aliphatic group may be straight, branched or cyclic and contains preferably from 1 to 25 carbon atoms, more preferably from 6 to 25 carbon atoms, particularly preferably from 6 to 20 carbon atoms. Specific examples of the aliphatic group include a methyl group, an ethyl group, a n-propyl group, an isopropyl group, a cyclopropyl group, a n-butyl group, an isobutyl group, a t-butyl group, an amyl group, an isoamyl group, a t-amyl group, a n-hexyl group, a cyclohexyl group, a n-heptyl group, a n-octyl group, a bicyclooctyl group, an adamantyl group, a n-decyl group, a t-octyl group, a dodecyl group, a hexadecyl group, an octadecyl group and a didecyl group.

The aromatic group will be described below.

The aromatic group may be an aromatic hydrocarbon group or an aromatic hetero ring group and is preferably an aromatic hydrocarbon group. As the aromatic hydrocarbon group, those which contain from 6 to 24 carbon atoms are preferred, and those which contain from 6 to 12 carbon atoms are more preferred. Specific examples of the ring in the aromatic hydrocarbon group include benzene, naphthalene, anthracene, biphenyl and terphenyl. As the aromatic hydrocarbon group, benzene, naphthalene and biphenyl are particularly preferred. As the aromatic hetero ring group, those which contain at least one of oxygen atom, nitrogen atom and sulfur atom are preferred. Specific examples of the hetero ring include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole and tetrazaindene. As the aromatic hetero ring group, pyridine, triazine and quinoline are particularly preferred.

The substituents T will be described in detail below.

As the substituents T, there are illustrated, for example, an alkyl group (containing preferably from 1 to 20 carbon atoms, more preferably from 1 to 12 carbon atoms, particularly preferably from 1 to 8 carbon atoms; e.g., a methyl group, an ethyl group, an isopropyl group, a t-butyl group, a n-octyl group, a n-decyl group, a n-hexadecyl group, a cyclopropyl group, a cyclopentyl group or a cyclohexyl group), an alkenyl group (containing preferably from 2 to 20 carbon atoms, more preferably from 2 to 12 carbon atoms, particularly preferably from 2 to 8 carbon atoms; e.g., a vinyl group, an allyl group, a 2-butenyl group or a 3-pentenyl group), an alkynyl group (containing preferably from 2 to 20 carbon atoms, more preferably from 2 to 12 carbon atoms, particularly preferably from 2 to 8 carbon atoms; e.g., a propargyl group or a 3-pentynyl group), an aryl group (containing preferably from 6 to 30 carbon atoms, more preferably from 6 to 20 carbon atoms, particularly preferably from 6 to 12 carbon atoms; e.g., a phenyl group, a biphenyl group or a naphthyl group), an amino group (containing preferably from 0 to 20 carbon atoms, more preferably from 0 to 10 carbon atoms, particularly preferably from 0 to 6 carbon atoms; e.g., an amino group, a methylamino group, a dimethylamino group, a diethylamino group or a dibenzylamino group), an alkoxy group (containing preferably from 1 to 20 carbon atoms, more preferably from 1 to 12 carbon atoms, particularly preferably from 1 to 8 carbon atoms; e.g., a methoxy group, an ethoxy group or a butoxy group), an aryloxy group (containing preferably from 6 to 20 carbon atoms, more preferably from 6 to 16 carbon atoms, particularly preferably from 6 to 12 carbon atoms; e.g., a phenyloxy group or a 2-naphthyloxy group), an acyl group (containing preferably from 1 to 20 carbon atoms, more preferably from 1 to 16 carbon atoms, particularly preferably from 1 to 12 carbon atoms; e.g., an acetyl group, a benzoyl group, a formyl group or a pivaloyl group), an alkoxycarbonyl group (containing preferably from 2 to 20 carbon atoms, more preferably from 2 to 16 carbon atoms, particularly preferably from 2 to 12 carbon atoms; e.g., a methoxycarbonyl group or an ethoxycarbonyl group), an aryloxycarbonyl group (containing preferably from 7 to 20 carbon atoms, more preferably from 7 to 16 carbon atoms, particularly preferably from 7 to 10 carbon atoms; e.g., a phenyloxycarbonyl group), an acyloxy group (containing preferably from 2 to 20 carbon atoms, more preferably from 2 to 16 carbon atoms, particularly preferably from 2 to 10 carbon atoms; e.g., an acetoxy group or a benzoyloxy group), an acylamino group (containing preferably from 2 to 20 carbon atoms, more preferably from 2 to 16 carbon atoms, particularly preferably from 2 to 10 carbon atoms; e.g., an acetylamino group or a benzoylamino group), an alkoxycarbonylamino group (containing preferably from 2 to 20 carbon atoms, more preferably from 2 to 16 carbon atoms, particularly preferably from 2 to 12 carbon atoms; e.g., a methoxycarbonylamino group), an aryloxycarbonylamino group (containing preferably from 7 to 20 carbon atoms, more preferably from 7 to 16 carbon atoms, particularly preferably from 7 to 12 carbon atoms; e.g., a phenyloxycarbonylamino group), a sulfonylamino group (containing preferably from 1 to 20 carbon atoms, more preferably from 1 to 16 carbon atoms, particularly preferably from 1 to 12 carbon atoms; e.g., a methanesulfonylamino group or a benzenesulfonylamino group),

a sulfamoyl group (containing preferably from 0 to 20 carbon atoms, more preferably from 0 to 16 carbon atoms, particularly preferably from 0 to 12 carbon atoms; e.g., a sulfamoyl group, a methylsulfamoyl group, a dimethylsulfamoyl group or a phenylsulfamoyl group), a carbamoyl group (containing preferably from 1 to 20 carbon atoms, more preferably from 1 to 16 carbon atoms, particularly preferably from 1 to 12 carbon atoms; e.g., a carbamoyl group, a methylcarbamoyl group, a diethylcarbamoyl group or a phenylcarbamoyl group), an alkylthio group (containing preferably from 1 to 20 carbon atoms, more preferably from 1 to 16 carbon atoms, particularly preferably from 1 to 12 carbon atoms; e.g., a methylthio group or an ethylthio group), an arylthio group (containing preferably from 6 to 20 carbon atoms, more preferably from 6 to 16 carbon atoms, particularly preferably from 6 to 12 carbon atoms; e.g., a phenylthio group), a sulfonyl group (containing preferably from 1 to 20 carbon atoms, more preferably from 1 to 16 carbon atoms, particularly preferably from 1 to 12 carbon atoms; e.g., a mesyl group or a tosyl group), a sulfinyl group (containing preferably from 1 to 20 carbon atoms, more preferably from 1 to 16 carbon atoms, particularly preferably from 1 to 12 carbon atoms; e.g., a methanesulfinyl group or a benzenesulfinyl group), a ureido group (containing preferably from 1 to 20 carbon atoms, more preferably from 1 to 16 carbon atoms, particularly preferably from 1 to 12 carbon atoms; e.g., a ureido group, a methylureido group or a phenylureido group), a phosphoric acid amido group (containing preferably from 1 to 20 carbon atoms, more preferably from 1 to 16 carbon atoms, particularly preferably from 1 to 12 carbon atoms; e.g., a diethylphosphoric acid amido group or a phenylphosphoric acid amido group), a hydroxyl group, a mercapto group, a halogen atom (e.g., a fluorine atom, a bromine atom or an iodine atom), a cyano group, a sulfo group, a carboxyl group, a nitro group, a hydroxamic acid group, a sulfino group, a hydrazino group, an imino group, a hetero ring group (containing preferably from 1 to 30 carbon atoms, more preferably from 1 to 12 carbon atoms; hetero atoms: e.g., nitrogen atom, oxygen atom and sulfur atom; specific examples: an imidazolyl group, a pyridyl group, a quinolyl group, a furyl group, a piperidyl group, a morpholino group, a benzoxazolyl group, a benzimidazolyl group and a benzothiazolyl group) and a silyl group (containing preferably from 3 to 40 carbon atoms, more preferably from 3 to 30 carbon atoms, particularly preferably from 3 to 24 carbon atoms; e.g., a trimethylsilyl group or a triphenylsilyl group). These substituents may further be substituted. Also, in the case where two or more substituents exist, they may be the same or different from each other. If possible, they may be connected to each other to form a ring.

Preferred examples of compounds represented by the formula (5) are shown below which, however, do not limit the invention in any way.

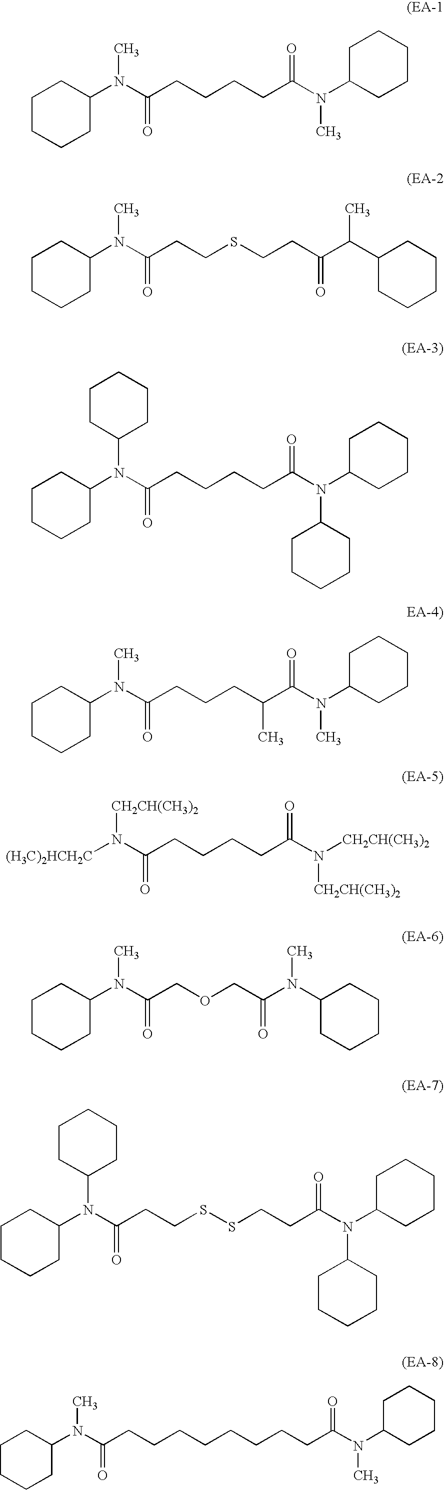

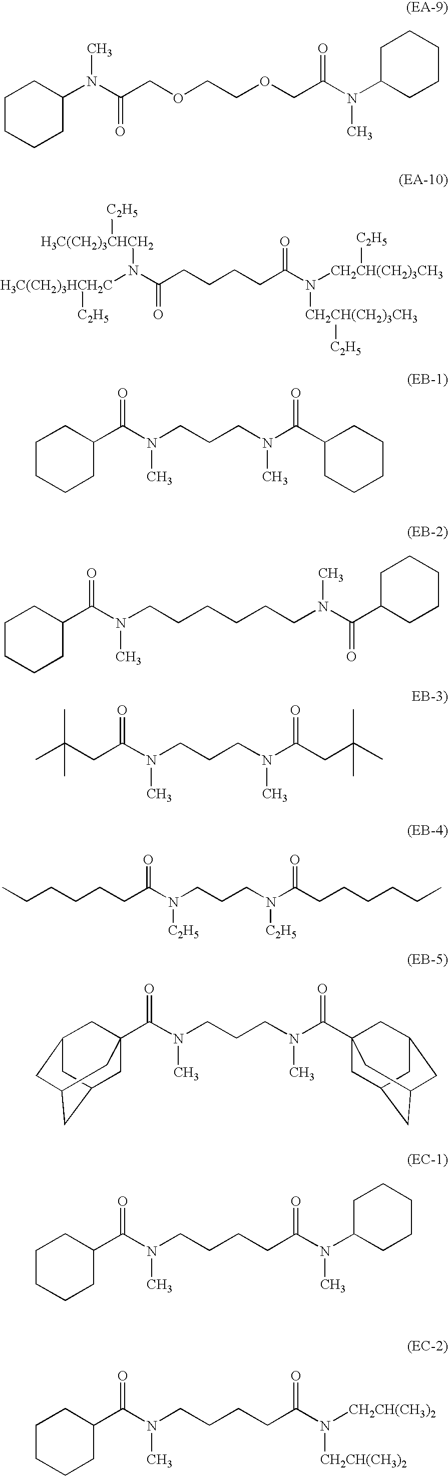

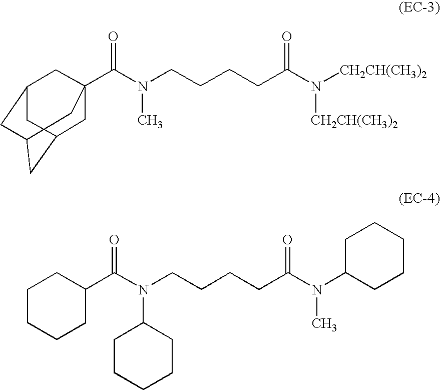

### (Processes for Synthesizing the Compounds)

The above-mentioned Rth decreasing agents and the Re decreasing agents to be preferably used in the invention can be synthesized according to the following processes.

The compounds of the formula (1) can be obtained by condensation reaction between a sulfonyl chloride derivative and an amine derivative. Also, the compounds of the formula (2) can be obtained by oxidation reaction of a sulfide or by Friedel-Crafts reaction between an aromatic compound and sulfonic acid chloride.

The compounds of the formulae (3), (4) and (5) can be obtained by dehydration condensation reaction between a carboxylic acid and an amine using a condensing agent (e.g., dicyclohexylcarbodiimide (DCC)) or by substitution reaction between a carboxylic acid chloride derivative and an amine derivative.

### (Addition Amount of the Compound)

The addition amount of the above-mentioned Rth decreasing agent and the Re decreasing agent to be preferably used in the invention is preferably from 0.01 to 30% by mass, more preferably from 0.1 to 20% by mass, particularly preferably from 0.2 to 10% by mass, based on the cyclic polyolefin resin. (In this specification, mass ratio is equal to weight ratio.)

In case when the addition amount exceeds 30% by mass, mixing of the agent with the substrate of cyclic polyolefin resin is obstructed, leading to whitening phenomenon in a part of, or the whole part of, the film.

Regarding the addition amount of two or more kinds of the compounds, the total addition amount is preferably from 0.01 to 30% by mass, more preferably from 0.1 to 20% by mass, particularly preferably from 0.2 to 10% by mass, based on the cyclic polyolefin resin.

### (Method for Adding the Compounds)

These compounds may be used independently or in combination of two or more thereof with any mixing ratio.

It is apparent that, in the case where an organic compound for decreasing the retardation in a thickness-direction Rth(λ) does not decrease the in-plane retardation Re(λ) or, reversely, in the case where an organic compound for decreasing the in-plane retardation Re(λ) does not decrease the retardation Rth(λ) in a thickness-direction, a desired retardations Re and Rth can be obtained by independently adjusting the addition amounts of the retardation decreasing agents. However, in the case where an organic compound for decreasing the retardation in a thickness-direction Rth(λ) also decrease the in-plane retardation Re(λ) or, reversely, in the case where an organic compound for decreasing the in-plane retardation Re(λ) also decreases the retardation Rth(λ) in a thickness-direction, a desired retardations Re and Rth can be obtained by adjusting the mixing amounts of the retardation decreasing agents.

Further, addition of the compounds may be performed in any steps of a process for preparing a dope or at the final stage of the dope-preparing process.

### (Fine Particles)

In the invention, film-forming stability and suitability for processing of the film can be improved and optical unevenness of the film caused by, for example, backlash of film can be reduced by adding fine particles to the above-described cyclic polyolefin resin. Since fine particles are not used in Examples, detailed descriptions on the fine particles to be used in the invention are omitted.

### (Additives)

Various additives (e.g., a deterioration-preventing agent, an ultraviolet ray-preventing agent, a peeling accelerator, a plasticizer, an infrared ray absorbent, etc.) can be added to the cyclic polyolefin film of the invention in the respective steps of producing the film according to the end use. They may be solid or oily materials. That is, they are not particularly limited as to the melting points or boiling points thereof. For example, it is possible to use a mixture of an ultraviolet ray absorbing material having a melting point of 20° C. or less and an ultraviolet ray absorbing material having a melting point of 20° C. or more. The same applies with a mixture of deterioration-preventing agents. Further, infrared ray-absorbing dyes are described in, for example, JP-A-2001-194522. Regarding the stage of the addition thereof, they may be added to any step in the process of preparing a cyclic polyolefin solution (dope). It is also possible to add a step of adding the additives to the final step of the dope-preparing process. Further, the addition amount of each material is not particularly limited as long as its function is exerted. In the case where the cyclic polyolefin film is formed by plural layers, kinds and amounts of the additives in the respective layers may be different from each other.

### <Deterioration-Preventing Agents>

In the invention, known deterioration (oxidation) preventing agents may be added to the cyclic polyolefin solution.

The addition amount of the antioxidant is from 0.05 to 5.0 parts by mass per 100 parts of the cyclic polyolefin resin.

### <Ultraviolet Ray Absorbents>

In the invention, an ultraviolet ray absorbent is preferably used in the cyclic polyolefin solution in view of preventing deterioration of a polarizing plate or a liquid crystal. As the ultraviolet ray absorbent, those which absorb visible light of 400 nm or longer in wavelength in a small degree are preferably used in view of excellent absorption of ultraviolet rays of 370 nm or shorter in wavelength and good liquid crystal display performance. The addition amount of the ultraviolet ray absorbent is preferably from 1 ppm to 1.0% by mass, more preferably from 10 to 1,000 ppm, based on the mass of the whole cyclic polyolefin film.

### <Plasticizers>

Cyclic polyolefin resins generally have a less flexibility than cellulose acetate and, when bending stress or shearing stress is applied to a film, cracks are liable to be formed in the film. Also, upon processing the film into an optical film, crazing is liable to generate in the cut portion, and tailings of cut film are liable to be produced. The produced tailings stain the optical film and causes optical defects. In order to solve these problems, a plasticizer can be added to the film.

As the plasticizer to be used, a proper one is preferably selected from among those compounds which are liquid at ordinary temperature and under ordinary pressure and have a boiling point of 200° C. or higher.

The addition amount of the plasticizer is from 0.5 to 40.0 parts by mass, preferably from 1.0 to 30.0 parts by mass, more preferably from 3.0 to 20.0 parts by mass, per 100 parts by mass of the cyclic polyolefin resin. In case when the addition amount of the plasticizer is less than the above-described range, there results only insufficient plasticizing effect, failing to improve suitability for processing whereas, in case when the addition amount exceeds the range, the plasticizer might be separated and ooze out to cause optical unevenness and stain other parts, thus such amount not being preferred.

The process for producing the cyclic polyolefin film of the invention will be described in detail below.

The process for producing the film of the invention is not particularly limited and includes melt casting processes and solution casting processes. As has been described hereinbefore, of the two type processes, the solution casting processes are particularly preferred. It is preferred to produce the cyclic polyolefin film by either of two processes among the solution casting processes. These processes have been described hereinbefore, but will be described in more detail below.

1. A process for producing a cyclic polyolefin film which includes a step of dissolving or dispersing a cyclic polyolefin resin and at least one compound, a step of casting the solution or dispersion, a drying step and a winding step.
2. A process for producing a cyclic polyolefin film which includes a step of dissolving a cyclic polyolefin resin, a step of casting the solution, a drying step and a winding step, with a step of applying a coating solution containing at least one compound to at least one side of the cast film being included.

Also, it is preferred to stretch the cast film after the casting step.

Additionally, the processes 1 and 2 are different from each other in the manner of incorporating the compound in the cyclic polyolefin film. In the process 1, the compound is dissolved or dispersed in one and the same layer containing the cyclic polyolefin resin as a major component whereas, in the process 2, a coating solution containing the compound is applied to the layer containing the cyclic polyolefin resin as a major component. Hereinafter, respective steps of from (a dissolving step for preparing a dope) to (a winding step after drying) will be described step by step below. The process 1 is the same as the process 2 except for dispersing or dissolving the compound to add in (the dissolving step for preparing a dope).

### (Dissolving Step for Preparing a Dope)

First, respective material components are dissolved in a solvent to be described hereinafter to prepare a cyclic polyolefin solution (dope). As to preparation of the dope, there are a method of dissolving at room temperature under stirring, a cool-dissolving method of first swelling a cyclic polyolefin resin, etc. by stirring at room temperature, and then cooling to −20 to −100° C., and again heating to 20 to 100° C., a high temperature-dissolving method of dissolving in a tightly closed vessel at a temperature equal to or higher than the boiling point of a main solvent, and a method of dissolving at a high temperature and a high pressure to a level of the critical point of the solvent. With cyclic polyolefin resins having a good solubility, the method of dissolving at room temperature is preferred and, with cyclic polyolefin resins having a poor solubility, they are dissolved by heating in a tightly closed vessel. With cyclic polyolefin resins having solubility not so poor, it is effective to select a temperature as low as possible.

In the invention, the viscosity of the cyclic polyolefin solution at 25 C is preferably from 1 to 500 Pa·s, more preferably from 5 to 200 Pa·s. The viscosity was measured as follows. 1 mL, of a sample solution was used, and measurement was conducted using a rheometer (CLS 500) and a 4 cm/2° Steel Cone (both being manufactured by TA Instruments).

The sample solution was subjected to measurement after being left at a temperature at which the measurement was to initiate till the solution temperature became constant.

The solvent to be used upon preparation of the dope is described below. In the invention, solvents which can be used in the invention are not particularly limited as long as they can exert there function of dissolving the cyclic polyolefin resin to permit casting to form a film. As the solvents to be used in the invention, those solvents are preferred which are selected from among chlorine-containing solvents such as dichloromethane and chloroform, straight-chain hydrocarbons, cyclic hydrocarbons, aromatic hydrocarbons, esters, ketones and ethers, which contain from 3 to 12 carbon atoms. Esters, ketones and ethers may have a cyclic structure. Examples of the straight-chain hydrocarbons containing from 3 to 12 carbon atoms include hexane, octane, iso-octane and decane. Examples of the cyclic hydrocarbons containing from 3 to 12 include cyclopentane, cyclohexane and the derivatives thereof. Examples of the aromatic hydrocarbons containing from 3 to 12 carbon atoms include benzene, toluene and xylene. Examples of the esters containing from 3 to 12 include ethyl formate, propyl formate, pentyl formate, methyl acetate and pentyl acetate. Examples of the ketones containing from 3 to 12 carbon atoms include acetone, methyl ethyl ketone, diethyl ketone, diisobutyl ketone, cyclopentanone, cyclohexanone and methylcyclohexanone. Examples of the ethers containing from 3 to 12 carbon atoms include diisopropyl ether, dimethoxymethane, dimethoxyethane, 1,4-dioxane, 1,3-dioxolane, tetrahydrofuran, anisole and phenetole. Examples of organic solvents having two or more functional groups include 2-ethoxyethyl acetate, 2-methoxyethanol and 2-butoxyethanol. A preferred boiling point of the organic solvent is from 35° C. to 150° C. With solvents to be used in the invention, two or more solvents may be mixed to use in order to adjust physical properties of the solution such as drying properties and viscosity and, further, a poor solvent may be added as long as the resulting mixed solvent can dissolve the cyclic polyolefin resin.

A preferred poor solvent can properly be selected according to polymer kinds to be used. In the case of using a chlorine-containing organic solvent as a good solvent, an alcohol can preferably be used as the poor solvent. The alcohol may be straight, branched or cyclic, with alcohols of saturated aliphatic hydrocarbon being preferred. The hydroxyl group of the alcohol may be primary, secondary or tertiary. Examples of the alcohol include methanol, ethanol, 1-propanol, 2-propanol, 1-butanol, 2-butanol, t-butanol, 1-pentanol, 2-methyl2-butanol and cyclohexanol. Additionally, fluorine-containing alcohols may also be used as the alcohols. Examples thereof include 2-fluoroethanol, 2,2,2-trifluoroethanol and 2,2,3,3-tetrafluoro-1-propanol. Of the poor solvents, primary alcohols are particularly preferably used since they have releasing resistance-reducing effect. Particularly preferred alcohols vary depending upon kinds of selected good solvents but, in view of drying load, alcohols having a boiling point of 120° C. or lower are preferred, and primary alcohols containing from 1 to 6 carbon atoms are more preferred. Alcohols containing from 1 to 4 carbon atoms can particularly preferably be used. A mixed solvent particularly preferred for preparing a solution of the cyclic polyolefin resin is a combination of a main solvent of dichloromethane and a poor solvent of one or more alcohols selected from among methanol, ethanol, propanol, isopropanol and butanol.

The cyclic polyolefin solution is characterized in that a highly concentrated dope can be obtained by properly selecting a solvent to be used. A cyclic polyolefin solution of a high concentration having excellent stability can be obtained without employing the means of concentration. Further, in order to render dissolution easier, the cyclic polyolefin may be dissolved in a low concentration, and then concentrated by employing a concentrating means. The concentrating method is not particularly limited. For example, it can be performed by a method of introducing a low concentration solution into the gap between a cylinder and rotation locus of the outer periphery of a rotary blade within the cylinder which blade rotates in the peripheral direction and giving them a temperature different from the temperature of the solution to thereby evaporate the solvent and obtain a high concentration solution (e.g., JP-A-4-259511) or by a method of blowing a heated low concentration solution through a nozzle into a vessel to conduct flash distillation of the solvent during the period wherein the solution travels from the nozzle to the inner wall of the vessel and, at the same time, removing the solvent vapor from the vessel and recovering a high concentration solution from the bottom of the vessel (e.g., U.S. Pat. Nos. 2,541,012, 2,858,229, 4,414,341 and 4,504,355).

Prior to casting, the solution is preferably filtered through a proper filtering material such as wire gauze or flannel to remove insolubles or extraneous matter such as dust and impurities. For filtration of the cyclic polyolefin solution, a filter of from 0.1 μm to 100 μm in absolute filtration accuracy is preferably used, with a filter of from 0.5 μm to 25 μm being more preferably used. The thickness of the filter is preferably from 0.1 μm to 10 mm, more preferably from 0.2 mm to 2 mm. In this case, filtration is performed under a filtration pressure of preferably from 1.6 MPa or less, more preferably 1.3 MPa or less, particularly preferably 0.6 MPa or less. As the filter material, conventionally known materials such as glass fibers, cellulose fibers, filter paper and fluorine-containing resin (e.g., tetrafluoroethylene resin) can preferably be used. Also, ceramics and metals can preferably be used.

As a process and equipment for producing the cyclic polyolefin film of the invention, the same solution-casting process for producing the film and the same solution-casting apparatus for producing the film as have conventionally been employed for producing cellulose triacetate film can be used. A dope (a cyclic polyolefin solution) prepared in a dissolving machine (tank) is once stored in a storage tank to remove foams contained in the dope for final adjustment. The dope is discharged through a discharge opening and is fed to a pressure type die via, for example, a pressure-type metering gear pump capable of feeding a liquid at a constant rate with a high accuracy. Then, the dope is uniformly cast onto an endlessly running metal support in a casting section through a nozzle (slit) of the pressure type die, and the half-dried dope film (also referred to as “web”) is released from the metal support at a releasing point where the metal support approximately makes a round. The web is nipped by means of clips at the both edges thereof and is conveyed by means of a tenter to dry, followed by being conveyed on rolls of a drying apparatus to complete drying. The thus dried film is wound with a predetermined length by means of a winding machine. Combination of the tenter and the drying apparatus containing a group of rolls varies depending upon the use of the film. In the solution-casting process for producing a film for use as a functional protective film for electronic displays, a coating apparatus is often added in addition to the solution-casting apparatus for producing the film in order to provide an undercoat layer, an antistatic layer, an anti-halation layer or a protective layer on the surface of the film. Individual steps will be described briefly below which, however, do not limit the invention in any way.

The prepared cyclic polyolefin solution (dope) is preferably cast onto an endless metal support, for example, a metal drum or a metal support (band or belt), followed by distilling off the solvent to form a film. The dope before casting is preferably adjusted so that the amount of the cyclic olefin becomes from 10 to 35% by mass. The surface of the drum or band is preferably planished. The dope is preferably cast onto a drum or a band having a surface temperature of 30° C. or less, particularly preferably from −50 to 20° C.

Further, cellulose acylate-filming techniques described in JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511 and JP-A-2-208650 can be applied to the invention.

### (Casting; Multilayer-Casting)

The cyclic polyolefin solution may be cast on a metal support of a plain band or drum as a single layer solution, or two or more, plural, cyclic polyolefin solutions may be cast thereon.

In the case of casting plural cyclic polyolefin solutions, the plural cyclic polyolefin solutions may be cast respectively through plural casting slits provided with a space between them in the direction in which the metal support runs to laminate the plural solutions and form a multi-layer film, and methods described in, for example, JP-A-61-158414, JP-A-1-122419 and JP-A-11-198285 can be applied.

Also, a film may be formed by casting cyclic polyolefin solutions through two casting slits. This method can be performed according to the methods described in, for example, JP-B-60-27562, JP-A-61-94724, JP-A-61-94725, JP-A-61-104813, JP-A-61-158413 and JP-A-6-134933. Further, there may be employed a method of forming the cyclic polyolefin film by casting in such manner that a flow of a high-viscosity cyclic polyolefin solution is enclosed by a low-viscosity cyclic polyolefin solution and the high-viscosity cyclic polyolefin solution and the low-viscosity cyclic polyolefin solution are simultaneously extruded, as described in JP-A-56-162617. Still further, as described in JP-A-61-94724 and JP-A-61-94725, the embodiment wherein the outer solution contains a poor solvent of an alcohol in a more amount than the inner solution is also a preferred embodiment. Also, a method of forming a film by using two casting slits, casting a solution onto a metal support through the first casting slit to form a film, releasing the film from the support, and subjecting the surface of the film having been in contact with the metal support surface to the second casting may be employed, this method being described in, for example, JP-B-44-20235. The cyclic polyolefin solutions to be cast may be the same or different from each other, and are not particularly limited. In order to impart functions to plural cyclic polyolefin layers, it suffices to extrude the plural cyclic polyolefin solutions with corresponding functions through respective casting slits. Further, the cyclic polyolefin solutions may be cast simultaneously with other functional layers (e.g., an adhesive layer, a dye layer, an antistatic layer, an anti-halation layer, a matt agent layer, a UV-absorbing layer and a polarizing layer).

In the case of forming a film by casting a single layer solution, it is necessary to extrude a cyclic polyolefin solution having a high concentration and a high viscosity. In this case, the cyclic polyolefin solution has a poor stability and tends to generate solids, which is liable to cause problems including seeding troubles and formation of poor flat properties. As a solution for the problems, plural cyclic polyolefin solutions having a high viscosity can be simultaneously extruded onto a metal support by casting them through respective casting slits. This method can produce a film having improved flat properties and excellent surface state and, in addition, can reduce the drying load by using a concentrated cyclic polyolefin solution, thus increasing the production speed of the film.

In the case of the co-casting, the thickness of the inner layer and the thickness of the outer layer are not particularly limited but, preferably, the thickness of the outer layer accounts for 1 to 50%, more preferably 2 to 30%, of the whole thickness. Here, in the case of co-casting three or more layers, the total thickness of the layer in contact with the metal support and the layer in contact with the air is defined as the thickness of the outer layer. With co-casting, cyclic polyolefin solutions different from each other in the concentration of the additive may be co-case to form a cyclic polyolefin film of a layered structure. For example, a cyclic polyolefin film of a structure of skin layer/core layer/skin layer can be prepared. A deterioration-preventing agent and a UV ray absorbent can be incorporated in a more amount in the core layer than in the skin layer, or may be incorporated only in the core layer. It is also possible to change the kinds of the deterioration-preventing agent and the UV ray absorbent. For example, it is possible to incorporate a low-volatile deterioration-preventing agent and/or UV ray absorbent in the skin layer and incorporate a plasticizer having excellent plasticizing ability or a UV ray absorbent having excellent UV ray-absorbing ability in the core layer. It is also a favorable embodiment to incorporate a releasing accelerator only in the skin layer on the metal support side. In order to cool the metal support by a cooling drum method for gelling of the solution, it is also preferred to add a poor solvent of an alcohol to the skin layer in a more amount than to the core layer. Tg of the skin layer may be different from Tg of the core layer, with Tg of the core layer being preferably lower than Tg of the skin layer. Further, the viscosity of the solution containing the cyclic polyolefin upon casting may be different between the skin layer and the core layer, and the viscosity of the skin layer is preferably smaller than the viscosity of the core layer. However, the viscosity of the core layer may be smaller than the viscosity of the skin layer.

### (Casting)

As a method for casting a solution, there are a method of uniformly extruding a prepared dope through a pressure die onto a metal support, a method using a doctor blade wherein a dope once cast onto a metal support is subjected to a blade to adjust the thickness, and a method using a reverse roll coater for adjusting the thickness by means of a reversely rotating roll, with a method using a pressure die being preferred. The pressure die includes a coat hunger type and a T-die type, with both being preferably used. Also, besides the above-described methods, various methods having conventionally been known for casting a cellulose triacetate solution to form a film can be performed, and the same effects as described in respective official gazettes can be obtained by establishing individual conditions in consideration of differences in boiling point of a solvent to be used and the like. As a metal support which runs endlessly and is used for producing the cyclic polyolefin film of the invention, a drum whose surface has been planished by chromium plating or a stainless steel belt (which may also be referred to as “a band”) whose surface has been planished by surface abrasion is used. Regarding the pressure die to be used for producing the cyclic polyolefin film of the invention, one, two or more pressure dies may be provided above the metal support, with one or two dies being preferred. In the case of providing two or more pressure dies, the amount of a dope to be cast may be separated into portions for respective dies, or the dope may be fed to respective dies in respective portions by means of a plurality of accurately metering gear pumps allocated for the dies. The temperature of the cyclic polyolefin solution to be used for casting is preferably from −10 to 55° C., more preferably from 25 to 50° C. In this case, the temperature may be the same throughout the whole steps, or may be different among the steps. Where the temperature is different among the steps, it suffices for the temperature to be at a desired level immediately before casting.

### (Drying)

With drying of the dope on the metal support in accordance with production of the cyclic polyolefin film, there are a method of applying a hot blast generally from the surface side of a metal support (e.g., a drum or a band), i.e., from the surface of the web on the metal support, a method of applying a hot blast from the back side of a drum or a band, and a method of a liquid heat transfer system wherein a temperature-controlled liquid is brought into contact with the back side of the band or drum opposite to the dope-cast side to heat the drum or band by heat transfer for controlling the surface temperature, with a method of a liquid heat transfer system of transferring heat through the liquid being preferred. The surface temperature of the metal support before casting may be any temperature as long as it is equal to or lower than the boiling point of a solvent used for the dope. However, in order to accelerate drying and remove flowability on the metal support, the temperature is preferably set at a level lower than the boiling point of the solvent having the lowest boiling point among the solvents used by about 1 to about 10 degrees. Additionally, in the case of cooling the cast dope and releasing it without drying, this does not apply.

### (Releasing)

In case where the releasing resistance (releasing load) is large upon releasing the half-dried film from the metal support, the film is irregularly stretched in the film-forming direction to generate unevenness in optical anisotropy. When the releasing load is particularly large, stretched portions and non-stretched portions are alternately generated stepwise to produce a distribution in retardation. When this film is mounted on a liquid crystal display device, there appears linear or band-like unevenness. In order not to cause such problems, the releasing load is preferably adjusted to 0.25 N or less per 1 cm of the film-releasing width. The releasing load is more preferably 0.2 N/cm or less, still more preferably 0.15 N/cm or less, particularly preferably 0.10 N/cm or less. In the case where the releasing load is 0.2 N/cm or less, unevenness due to releasing is not observed at all even in a liquid crystal display device which is liable to give unevenness. As a method for reducing the releasing load, there are a method of adding a releasing agent as has been described hereinbefore and a method of selecting formulation of solvents to be used.

The releasing load is measured in the following manner. A dope is dropped on a metal plate having the same material and the same surface roughness as those of the metal support in the film-forming apparatus, and is spread to a uniform thickness using a doctor blade, followed by drying. Notches are formed with uniform width in the film using a cutter knife, and the tip of the film is peeled by hand and is gripped by a clip connected to a strain gauge. The strain gauge is drawn up in the direction of oblique 45°, during which the change in load is measured. The content of volatile components in the released film is measured as well. The same measurement is repeated several times with changing the drying period to determine the releasing load when the content of the residual volatile components is the same as that upon releasing in the actual film-producing steps. As the releasing speed increases, the releasing load tends to become larger, and hence the measurement is preferably conducted at a releasing speed approximate the actual releasing speed.

The content of residual volatile components upon releasing is preferably from 5% by mass to 60% by mass, more preferably from 10% by mass to 50% by mass, particularly preferably from 20% by mass to 40% by mass. When releasing is conducted at a stage where the content of volatile components is at a high level, drying can be conducted in a shorter period, which serves to improve productivity and is, therefore, preferred. On the other hand, when releasing is conducted at a stage where the content of volatile components is at a high level, the film has a small strength and a small elasticity and might be broken or stretched with yielding to the releasing force. In addition, the self-retaining force of the released film is insufficient and the film is liable to suffer deformation and formation of wrinkles and knicks. Also, it can be the cause of generating distribution in retardation.

### (Stretching Treatment)

In the case of stretch-treating the cyclic polyolefin film of the invention, it is preferred to conduct stretching treatment while a solvent still remains in the film in a sufficient amount. Stretching is conducted for the purposes of (1) obtaining a film which does not suffer formation of wrinkles or deformation and which is excellent in flat properties and (2) increasing in-plane retardation of the film. In the case of conducting stretching for the purpose (1), stretching is conducted at a comparatively high temperature with a low stretch ratio of from 1% to 10% at the highest. The stretch ratio is particularly preferably from 2% to 5%. In the case of conducting stretching for the both purposes (1) and (2) or for the purpose of (2) alone, stretching is conducted at a comparatively low temperature with a stretch ratio of from 5% to 150% at the highest.

Stretching of the film may be mono-axial stretching in the longitudinal or transverse direction alone or may be simultaneous or successive biaxial stretching. Regarding the birefringence of an optically-compensatory film for use in a VA mode liquid crystal cell or an OCB mode liquid crystal cell, the refractive index in the width direction is preferably larger than the refractive index in the longitudinal direction. Therefore, it is preferred to more stretch in the width direction.

### (Post Drying, Winding Step)

The stretched cyclic polyolefin film is further dried to reduce the content of volatile components to 2% or less, followed by winding it.

The thickness of the finished (dried) cyclic polyolefin film of the invention varies depending upon the purpose for use, but is usually in the range of from 20 to 500 μm, preferably from 30 to 150 μm and, for use in a liquid crystal display device, particularly preferably from 40 to 110 μm.

Adjustment of the film thickness to a desired level may be performed by adjusting concentration of solid components contained in the dope, slit gap of die nozzles, extruding pressure from dies and speed of the metal support. The width of the thus-obtained cyclic polyolefin film is preferably from 0.5 m to 3 m, more preferably from 0.6 m to 2.5 m, still more preferably from 0.8 m to 2.2 m. When the width is equal to 0.5 m or loner than that, productivity is not reduced whereas, when the width is equal to 3 m or shorter than that, web-handling properties are not deteriorated and optical uniformity of the film is not reduced and, further, non-favorable phenomena such as twist and streak do not occur, thus such width being preferred. With respect to the film length, it is preferred to wind up with a length of preferably from 100 m to 10,000 m, more preferably from 500 m to 7,000 m, still more preferably from 1,000 m to 6,000 m, per roll. When the film length is 100 m or longer, reduction of productivity due to large frequency of roll exchange can be avoided whereas, when the film length is 10,000 m or shorter, web-handling properties are not deteriorated and optical uniformity of the film is not reduced and, further, non-favorable phenomena such as twist and streak do not occur, thus such length being preferred. Upon winding up, it is preferred to provide knurling on at least one edge with a width of preferably from 3 mm to 50 mm, more preferably from 5 mm to 30 mm, and a height of preferably from 0.5 to 500 μm, more preferably from 1 to 200 μn. This may be one-side press or both-side press. Scattering of the Re value of the whole width is preferably within ±5 nm, more preferably within ±3 nm. Also, scattering of the Rth value is preferably within ±110 nm, more preferably within ±5 nm. Further, scattering of the Re value and the Rth value in the longitudinal direction are preferably within the same range as that with scattering in the width direction. In order to maintain transparent appearance, the haze is preferably from 0.01 to 2%.

### (Thickness of the Cyclic Polyolefin Film)

With both the cyclic polyolefin film having a large thickness and the cyclic polyolefin film having a small thickness, Re(λ) and Rth(λ) can be adjusted by incorporating additives. That is, a controllable region of the optical properties can further be enlarged by adding an Re adjusting agent and an Rth adjusting agent as additives to a thin film. Also, ideally, the controllable region of the optical properties can be enlarged by reducing the thickness of the film but, on the other hand, the film thickness must be at least 30 μm in view of casting suitability. The film thickness is preferably from 35 to 90 μm, more preferably from 40 to 80 μm.

### (Optical Properties of the Cyclic Polyolefin Film)

Preferred optical properties of the cyclic polyolefin film of the invention vary depending upon the use of the film. Preferred optical properties thereof for use as protective film for a polarizing plate and as optically-compensatory film will be described in the items hereinafter.

With the cyclic polyolefin film of the invention, desired optical properties can be realized by properly adjusting or selecting structure of the cyclic polyolefin resin to be used, kinds and amounts of additives, and process conditions such as stretch ratio and the content of residual volatile components upon releasing.

In this specification, Re(λ) and Rth(λ) respectively represent in-plane retardation and retardation in a thickness-direction. Re(λ) can be measured by irradiating with an incident light of λ nm in wavelength in the normal direction of the film using KOBRA 21ADH (manufactured by Ohji Measurement Co., Ltd.). Rth(λ) can also be calculated by KOBRA 21 ADH based on retardation values obtained by measuring the Re(λ) in 6 directions by irradiating with an incident light of λ nm in wavelength in the direction inclined at an angle stepwise varying, by 10°, to 50° from the normal line of the film with taking the slow axis in plane (determined by KOBRA 21ADH) as an inclination axis (rotation axis)(in the case where there exists no slow axis, any direction in film plane being taken as the rotation axis), an assumed value of average refractive index and the inputted film thickness value. Additionally, the Rth value can also be calculated according to the following formulae (1) and (2) based on retardation values obtained by measuring in any two directions, an assumed value of average refractive index and the inputted film thickness value. Here, as the assumed value of average refractive index, those described in a polymer handbook (John Wiley & Sons, Inc.) and catalogues of various optical films can be used. As to films whose average refractive index is unknown, it can be known by measuring with an Abbe's refractometer. Values of average refractive index of main films are illustrated below. Cellulose acylate (1.48), cycloolefin polymer (1.52), polycarbonate (1.59), polymethyl methacrylate (1.49) and polystyrene (1.59).

nₓ, n_{y} and n_{z} are calculated by imputing these assumed average refractive index values and the thickness into KOBRA 21ADH. N_{z}=(nₓ−n_{z})/(nₓ−n_{y}) is further calculated from the thus calculated nₓ, n_{y} and n_{z}.

$$Re ( θ ) = [ nx = \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \\ \frac{d}{cos ( {sin}^{- 1} ( \frac{sin ( - θ )}{nx} ) )} \qquad Formula ( 1 )$$

In formula (1), Re(θ) represents a retardation value in the direction inclined from the normal direction by θ, and d represents a thickness.

Rth=((nₓ+n_{y})/2−n_{z})×d Formula (2)

Additionally, as the average refractive index n which becomes necessary as a parameter, a value obtained by measuring with an Abbe's refractometer (Abbe's refractometer 2-T, manufactured by ATAGO CO., LTD.) can be used. In this specification, wavelength of light used for the measurement is 590 nm unless otherwise specified.

Next, a protective film for a polarizing plate having the cyclic polyolefin film of the invention, an optically-compensatory film, and a polarizing plate characterized by having the protective film for the polarizing plate will be described below.

### (Retardation Film—Optically-Compensatory Film)

In the case of using the cyclic polyolefin film as a retardation film, ranges of Re and Rth of the retardation film vary depending upon kind of the film, with various needs existing. It is preferred to use the film as an optically-compensatory film. The optically-compensatory film of the invention may be the cyclic polyolefin film of the invention itself or may have other constituting layers to be described hereinafter. It is also preferred for the film to have a substituent having a large polarizability within the molecule in a proper proportion.

In the case of being used as an optically-compensatory film, optical properties of the cyclic polyolefin film of the invention are preferably 0 nm≦Re≦100 nm and 40 nm≦Rth≦400 nm. With TN mode, the optical properties are more preferably 0 nm≦Re≦20 nm and 40 nm≦Rth≦80 nm and, with VA mode, the optical properties are more preferably 20 nm≦Re≦80 nm and 80 nm≦Rth≦400 nm, particularly preferably 30 nm≦Re≦75 nm and 120 nm≦Rth≦250 nm. In view of color shift upon black display and viewing angle dependence of contrast, a particularly preferred embodiment of VA mode optically-compensatory film is an embodiment that, in the case where compensation is performed by using one optically-compensatory film, the optical properties of the film are preferably 50 nm≦Re≦75 nm and 180 nm≦Rth≦250 nm and, in the case where compensation is performed by using two optically-compensatory films, the optical properties of the film are preferably 30 nm≦Re≦50 nm and 80 nm≦Rth≦140 mm.

### (Protective Film for a Polarizing Plate)

In the case of using the cyclic polyolefin film of the invention as a protective film for a polarizing plate, the in-plane retardation (Re) is preferably 5 nm or less, more preferably 3 nm or less. Also, the retardation in a thickness-direction (Rth) is preferably 50 nm or less, more preferably 35 nm or less, particularly preferably 10 nm or less.

The protective film of the invention for a polarizing plate may be the cyclic polyolefin film of the invention itself or may have other constituting layers to be described hereinafter.

### (Polarizing Plate)

A polarizing plate usually comprises a polarizer having two transparent protective films provided on both sides thereof respectively. The protective film of the invention for a polarizing plate is used as both or either of the protective films. In the case of using the protective film of the invention for a polarizing plate only on one side of the polarizer, other protective film to be used may be a conventional cellulose acetate film. The polarizer includes an iodine series polarizer, a dye series polarizer using a dichroic dye and a polyene series polarizer. The iodine series polarizer and the dye series polarizer are generally produced by using a polyvinyl alcohol (PVA) series film. PVA is a polymer material obtained by saponification of polyvinyl acetate and may contain a component copolymerizable with vinyl acetate, such as an unsaturated carboxylic acid, an unsaturated sulfonic acid, an olefin or a vinyl ether. Also, modified PVA containing an acetoacetyl group, a sulfonic acid group, a carboxyl group or an oxyalkylene group may be used.

The saponification degree of PVA is not particularly limited but, in view of solubility, it is preferably from 80 to 100 mol %, particularly preferably from 90 to 100 mol %. The polymerization degree of PVA is not particularly limited, but is preferably from 1,000 to 10,000, particularly preferably from 1,500 to 5,000.

As is described in Japanese Patent No. 2,978,219, the syndiotaticity of PVA is preferably 55% or more, but a syndiotacticity of from 45 to 52.5% described in Japanese Patent No. 3,317,494 can also preferably be used.

In the case of using the cyclic polyolefin film of the invention as a protective film for a polarizing plate and for a retardation film, it is preferred to subject the film to the surface treatment as described hereinafter and stick the treated surface of the film to a polarizer with an adhesive. The polarizing plate is constituted by a polarizer having provided on each side thereof a protective film and, further, a protect film is stuck onto one side of the polarizing plate and a separate film is stuck onto the opposite side thereof. The protect film and the separate film are used for protecting the polarizing plate upon shipping and checking the polarizing plate. In this occasion, the protect film is stuck for the purpose of protecting the surface of the polarizing plate and is used on the opposite side of the polarizing plate to the side to be stuck onto a liquid crystal plate. Also, the separate film is used for the purpose of covering an adhesive layer to be stuck onto the liquid crystal plate and is used on the side of the polarizing plate to be stuck onto the liquid crystal plate.

The protective film of the invention for a polarizing plate is preferably stuck onto a polarizer in such manner that the transmission axis of the polarizer coincides with the slow axis of the protective film of the invention for a polarizing plate. Additionally, evaluation of a polarizing plate prepared under a cross-Nicol position revealed that, if the slow axis of the protective film of the invention for a polarizing plate crosses at right angles with the absorption axis of the polarizer (axis crossing at right angles with the transmission axis) with an accuracy larger than 1°, there arises leakage of light due to deterioration of polarizing performance under a cross-Nicol position, which leads to failure to obtain a sufficient black level or a sufficient contrast when combined with a liquid crystal cell. Thus, deviation between the direction of the main refractive index nₓ of the protective film of the invention for a polarizing plate and the direction of the transmission axis of the polarizing plate is preferably within 1°, more preferably within 0.50.

UV3100PC (manufactured by Shimadzu Mfg. Works) can be used for measuring the single plate transmittance TT, the parallel transmittance PT and the orthogonal transmittance CT of a polarizing plate. The measurement is conducted in the range of from 380 nm to 780 nm, and values obtained by measuring 10 times are averaged with the single plate transmittance, the parallel transmittance and the orthogonal transmittance.

The durability test of polarizing plate can be conducted in the following manner using two embodiments: embodiment (1) comprising a polarizing plate alone; and embodiment (2) wherein a polarizing plate is stuck onto a glass via an adhesive. For measurement with the embodiment (1), two same samples are prepared to measure which samples comprise a protective film for a polarizing plate sandwiched between two polarizers provided in an orthogonal relation. With the embodiment (2) of being stuck onto a glass, two samples (about 5 cm×5 cm) are prepared wherein a polarizing plate is provided so that the protective film for the polarizing plate is on the glass side. In the measurement of the single plate transmittance, the sample is set with the film side of the sample facing toward a light source. The two samples are subjected to the measurement, and the average value of the two measured values is taken as the single plate transmittance. Preferred ranges of polarizing performance in the order of the single plate transmittance TT, the parallel transmittance PT and the orthogonal transmittance CT of the polarizing plate are: 40.5≦TT≦45, 32≦PT≦39.5 and CT≦1.5, more preferably 41.0≦TT≦44.5, 34≦PT≦39.0 and CT≦1.3. In the durability test of polarizing plate, a smaller amount of variation is more preferred.

### (Surface Treatment of the Cyclic Polyolefin Film)

The protective film of the invention for a polarizing plate is preferably subjected to surface treatment of the surface of the cyclic polyolefin film in order to improve adhesion properties to the polarizer. As to surface treatment, any method may be employed as long as adhesion properties of the surface can be improved. Preferred surface treatment includes glow discharge treatment, UV ray irradiation treatment, corona treatment and flame treatment. The term “glow discharge treatment” as used herein means a treatment of using so-called low-temperature plasma to be caused under a low-pressure gas. In the invention, plasma treatment under atmospheric pressure is also preferred. Other detailed descriptions on the glow discharge treatment are described in U.S. Pat. Nos. 3,462,335, 3,761,299 and 4,072,769 and British Patent No. 891,469. A method described in JP-T-59-556430 (the term “JP-T” as used herein means a published Japanese translation of a PCT patent application) is also employed wherein formulation of a gas in the discharge atmosphere after initiation of discharge includes only gas species generating within the vessel as a result of discharge treatment of polyester support itself. Also, a method described in JP-B-60-16614 can be employed wherein the surface temperature of the film upon vacuum glow discharge treatment is adjusted to between 80° C. and 180° C. to perform discharge treatment.

The vacuum degree upon glow discharge treatment is preferably from 0.5 Pa to 3,000 Pa, more preferably from 2 Pa to 300 Pa. The voltage is preferably between 500 V and 5,000 V, more preferably between 500 V and 3,000 V. The discharge frequency to be employed is from direct current to several thousands MHz, more preferably from 50 Hz to 20 MHz, still more preferably from 1 KHz to 1 MHz. The discharge treatment intensity is preferably from 0.01 kV·A·min/m² to 5 kV·A·min/m², more preferably from 0.15 kV·A·min/m² to 1 kV·A·min/m².

In the invention, a UV ray irradiation method is also preferred as the surface-treating method. For example, surface treatment can be conducted according to the treating methods described in JP-B-43-2603, JP-B-43-2604 and JP-B-45-3828. As the mercury lamp, a high-pressure mercury lamp emitting ultraviolet rays of from 180 to 380 nm in wavelength is preferred. As to method of irradiating with ultraviolet rays, a high-pressure mercury lamp of 365 nm in main wavelength can be used as a light source if the protective film does not suffer performance troubles as a support even when the surface temperature thereof increases as high as about 150° C. In the case where low-temperature treatment is required, a low-pressure mercury lamp of 254 nm in main wavelength is preferred. Also, a high-pressure mercury lamp and a low-pressure mercury lamp of ozone-less type can be used. With respect to the amount of treating light, a larger amount of treating light serves to more improve adhesion force between the polymer resin containing a thermoplastic saturated alicyclic structure and the poloarizer can be obtained. However, as the amount of light increases, there arise problems that the film is colored and becomes fragile. Therefore, with the high-pressure mercury lamp of 365 nm in main wavelength, the amount of irradiated light is preferably from 20 mJ/cm² to 10,000 mJ/cm², more preferably from 50 mJ/cm² to 2,000 mJ/cm². With the low-pressure mercury lamp of 254 nm in main wavelength, the amount of irradiated light is preferably from 100 mJ/cm² to 10,000 mJ/cm², more preferably from 300 mJ/cm² to 1,500 mJ/cm².

In the invention, corona discharge treatment is also preferably conducted as the surface treatment. It can be conducted according to the treating methods described in, for example, JP-B-39-12838, JP-A-47-19824, JP-A-48-28067 and JP-A-52-42114. As the corona discharge treating apparatus, there can be employed a solid-state corona treating machine manufactured by Pillar, a LEPEL type surface treating machine and a VETAPHON type surface treating machine. The treatment can be conducted in the air under ordinary pressure. The discharge frequency upon treatment is preferably from 5 kV to 40 kV, more preferably from 10 kV to 30 kV, with waveform being preferably a sine wave. The gap transparent lance between electrode and dielectric roll is preferably from 0.1 mm to 10 mm, more preferably from 1.0 mm to 2.0 mm. Discharge treatment is conducted above a dielectric support roller provided in a discharge zone, with the treating amount being preferably from 0.34 kV·A·min/m² to 0.4 kV·A·min/m², more preferably from 0.344 kV·A·min/m to 0.38 kV·A·min/m².

In the invention, flame treatment is also preferably conducted as the surface treatment. The gas to be used may be any of natural gas, liquefied propane gas and town gas. The ratio with the air is of importance. Because, the effect of surface treatment by the flame treatment is considered to be brought about by plasma which contains active oxygen. It is the point how much is the plasma activity (temperature) which is an important property of the flame and how much is oxygen. A controlling factor of this point is the gas/oxygen ratio. The energy density becomes maximum and the activity of plasma increases when the gas and oxygen react with each other neither too much nor too small. Specifically, the mixing ratio of natural gas/air is from 1/6 to 1/10, preferably from 1/7 to 1/9, by volume. With a liquefied propane gas/air, the ratio is from 1/14 to 1/22, preferably from 1/16 to 1/19 and, with a town gas/air, the ratio is from 1/2 to 1/8, preferably from 1/3 to 1/7. The flame-treating amount is preferably from 1 kCal/m² to 50 kCal/m² (4.18 kJ/m² to 209 J/m²), more preferably from 3 kCal/m² to 20 kCal/m² (12.5 kJ/m² to 83.6 J/m²). Also, the distance between the tip of the inner flame of a burner and the film is adjusted to preferably 3 cm to 7 cm, more preferably 4 cm to 6 cm. As to the shape of nozzle of the burner, a ribbon type shape by Furin Burner Co. (USA), a multi-hole type shape by Wise Co. (USA), a ribbon type shape by Aerogen Co. Ltd. (Great Britain), a zigzag multi-hole type by Kasuga Denki (Japan) and a zigzag multi-hole type by Koike Sanso (Japan) are preferred. A buck-up roll for supporting the film upon flame treatment is a hollow roll through which cooling water is passed to cool with water. The treatment is preferably conducted at a constant temperature of from 20° C. to 50° C.

Regarding the degree of surface treatment, a preferred range varies depending upon kind of the surface treatment and kind of the cyclic polyolefin, but the degree is preferably such that, as a result of the surface treatment, the contact angle between the surface of the surface-treated protective film and pure water becomes less than 50°. The contact angle is more preferably from 25° to less than 45°. When the contact angle between the surface of the protective film and pure water is within the above-described range, the adhesion strength between the protective film and the polarizing film is improved.

### (Adhesive)

Upon sticking a polarizer comprising a polyvinyl alcohol series film and the cyclic polyolefin film having been surface-treated as a protective film for a polarizing plate to each other, use of an adhesive containing a water-soluble polymer is preferred. Examples of the water-soluble polymer to be preferably used for the adhesive include homopolymers or copolymers containing as constituents ethylenically unsaturated monomers such as N-vinylpyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylamide, diacetoneacrylamide and vinylimidazole, polyoxyethylene, polyoxypropylene, poly-2-methyloxazoline, methyl cellulose, hydroxyethyl cellulose, hydroxypropyl cellulose, gelatin, etc. Of these, PVA and gelatin are preferred in the invention.

Preferred PVA properties in the case of using PVA as an adhesive are the same as the preferred properties of PVA to be used for a polarizer. In the invention, it is preferred to use a cross-linking agent in combination with PVA. Examples of the cross-linking agent to be preferably used in combination with PVA for adhesives include boric acid, polyvalent aldehydes, multi-functional isocyanate compounds and multi-functional epoxy compounds, with boric acid being particularly preferred in the invention. In the case of using gelatin as an adhesive, so-called lime-treated gelatin, acid-treated gelatin, enzyme-treated gelatin, gelatin derivatives and modified gelatins can be used. Of these gelatins, lime-treated gelatin and acid-treated gelatin are preferably used. In the case of using gelatin as an adhesive, examples of the cross-linking agent to be preferably used in combination with PVA include active halogen compounds (e.g., 2,4-dichloro-6-hydroxy-1,3,5-triazine and the sodium salt thereof), active vinyl compounds (e.g., 1,3-bisvinylsulfonyl-2-propanol, 1,2-bis(vinylsulfonylacetamido)ethane, bis(vinylsulfonylmethyl)ether and vinyl polymers having a vinylsulfonyl group in the side chain), N-carbamoylpyridinium salts ((1-morpholinocarbonyl-3-pyridinio)methane sulfonate) and haloamidinium salts (1-(1-chloro-1-pyridinomethylene)pyrrolidinium 2-naphthalenesulfonate)). In the invention, the active halogen compounds and the active vinyl compounds are particularly preferably used.

The addition amount of the cross-linking agent to be used in combination with PVA is preferably 0.1 part by mass or more and less than 40 parts by mass, more preferably 0.5 part by mass or more and less than 30 parts by mass, per 100 parts by mass of the water-soluble polymer in the adhesive. It is preferred to coat the adhesive on at least one surface of the protective film or the polarizer to thereby form an adhesive layer for sticking, and it is preferred to coat the adhesive on the surface-treated side of the protective film to form an adhesive layer and stick the adhesive layer to the surface of the polarizer. The dry thickness of the adhesive layer is preferably from 0.01 μm to 5μ, particularly preferably from 0.05 μm to 3 μm.

### (Anti-Reflection Layer)

A functional layer such as an anti-reflection layer is preferably provided on a transparent protective film to be provided on the opposite side of the polarizing plate to a liquid crystal cell side. Particularly, in the invention, an anti-reflection layer wherein at least a light-scattering layer and a low refractive index layer are laminated in this order or an anti-reflection layer wherein a middle refractive index layer, a high refractive index layer and a low refractive index layer are laminated in this order is preferably used on the transparent protective film. That is, it is preferred to use a transparent protective film as the transparent support on which the anti-reflection layer is laminated. Preferred examples thereof will be described below.

An example is described below wherein an anti-reflection layer comprising a light-scattering layer and a low refractive index layer is provided on a transparent protective layer. It is preferred for matt particles to be dispersed in the light-scattering layer. The light-scattering layer may have both anti-glare properties and hard coat properties, and may be constituted by one layer or plural layers (e.g., two layers to four layers).

With the anti-reflection layer, sufficient anti-glare properties and visually uniform matt appearance can be obtained by designing the surface unevenness so that the center-line average roughness Ra is from 0.08 to 0.40 μm, the 10-point average roughness Rz is 10 times as much as Ra or less than that, the average peak-to-valley distance Sm is from 1 to 100 μm, the standard deviation of the height of projection from the deepest portion of the unevenness is equal to or less than 0.5 μm, the standard deviation of the average peak-to-valley distance Sm based on the center line is 20 μm or less, and surface portions with an inclination angle of 0 to 5 degrees account for 10% or more, thus such unevenness being preferred.

Also, the tint of reflected light can be made neutral by adjusting the tint of reflected light under light source C to −2 to 2 in terms of a* value and −3 to 3 in terms of b* and adjusting the ratio of the minimum value of reflectance to the maximum value of reflectance in the range of from 380 nm to 780 nm to 0.5 to 0.99, which is preferred. The yellowish tint of white display experienced when applied to a display device can be reduced by adjusting b* value of a transmitted light under light source C to 0 to 3, thus such adjustment being preferred.

When the standard deviation of luminance distribution measured on a film by inserting a 120 μm×40 μm between a plane light source and the anti-reflection layer is 20 or less, a highly fine panel using the film of the invention suffers less dazzling, thus such luminance distribution being preferred.

With the anti-reflection layer, reflection of external light can be suppressed by adjusting the specular reflectance to 2.5% or less, the transmittance to 90% or more and the 60-degree gloss to 70% or less, which serves to improve viewability, thus being preferred. In particular, the specular reflectance is more preferably 1% or less, most preferably 0.5% or less. Dazzling on a highly fine LCD panel can be prevented and blurring of letters can be reduced by adjusting the haze to 20% to 50%, the ratio of internal haze/entire haze to 0.3 to 1, the reduction from the haze value after formation of the light-scattering layer to the haze value after formation of the low refractive index layer to a level within 15%, the transmitted image sharpness in comb width of 0.5 mm to 20 to 50% and the transmission ratio of the vertically transmitted light/the transmitted light in the direction inclined from the vertical direction by 2 degrees to 1.5 to 5.0, thus such adjustment being preferred.

### (Low Refractive Index Layer)

The refractive index layer of the low refractive index layer in the anti-reflection layer is in the range of preferably from 1.20 to 1.49, more preferably from 1.30 to 1.44. Further, in view of reducing reflectance, it is preferred for the low refractive index layer to satisfy the following numerical formula:

(m/4)×0.7<n1d1<(m/4)×1.3

wherein m represents a positive odd number, n1 represents the refractive index of the low refractive index layer, and d1 represents the thickness (nm) of the low refractive index. Also, λ represents a wavelength which is a value in the range of from 500 nm to 550 nm.

Materials for forming the low refractive index layer will be described below.

The low refractive index layer preferably contains a fluorine-containing polymer as a binder having a low refractive index. As the fluorine-containing polymer, those fluorine-containing polymers are preferred which have a dynamic friction coefficient of from 0.03 to 0.20, a contact angle for water of from 90° to 120° and a slide-down angle of pure water of 70° or less and which can be cross-linked by heat or ionization radiation. When mounted on an image display device, an anti-reflection layer requiring less releasing force for releasing a commercially available adhesive tape from the layer permits peeling of seals or memos stuck onto the layer with more ease, thus such anti-reflection layer being preferred. The releasing force is preferably 500 gf (4.9 N) or less, more preferably 300 gf (2.94 N), most preferably 100 gf (0.98 N) or less. Also, an anti-reflection layer having a higher surface hardness measured by a micro-hardness tester is more difficult to be scratched. The surface hardness is preferably 0.3 GPa or more, more preferably 0.5 GPa or more.

As the fluorine-containing polymer to be used in the low refractive index layer, there are illustrated hydrolyzates and dehydration condensates of perfluoroalkyl group-containing silane compounds (e.g., heptafluoro-1,1,2,2-tetrahydrodecyl)triethoxysilane) and fluorine-containing copolymers containing a fluorine-containing monomer unit and a constitution unit for imparting cross-linking reactivity as constitution units.

Specific examples of the fluorine-containing monomer include fluoroolefins (e.g., fluoroethylene, vinylidene fluoride, tetrafluoroethylene, perfluorooctylethylene, hexafluoropropylene and perfluoro-2,2-dimethyl-1,3-dioxol), partially or completely fluorinated alkyl ester derivatives of (meth)acrylic acid (e.g., Viscoat 6FM (manufactured by Osaka Organic Chemical Industry Ltd.) and M-2020 (manufactured by Daikin Industries) and completely or partially fluorinated vinyl ethers, with perfluoroolefins being preferred. In view of refractive index, solubility, transparency and availability, hexafluoropropylene is particularly preferred.

As the constitution unit for imparting cross-linking reactivity, there are illustrated constitution units obtained by polymerization of monomers previously containing self-cross-linking functional group within the molecule such as glycidyl (meth)acrylate and glycidyl vinyl ether, constitution units obtained by polymerization of monomers having a carboxyl group, a hydroxyl group, an amino group or a sulfo group (e.g., (meth)acrylic acid, methylol (meth)acrylate, hydroxyalkyl (meth)acrylate, allyl acrylate, hydroxyethyl vinyl ether, hydroxybutyl vinyl ether, maleic acid and crotonic acid) and constitution units obtained by introducing a cross-linkable group such as a (meth)acryloyl group into these constitution units through high molecular reaction (introduction being performed by, for example, acting acrylic chloride on a hydroxyl group).

Besides the fluorine-containing monomer units and the constitution units for imparting cross-linking reactivity, fluorine atom-free monomers can properly be copolymerized in view of solubility for a solvent and transparency of resulting film. The copolymerizable monomer units are not particularly limited, and examples thereof include olefins (e.g., ethylene, propylene, isoprene, vinyl chloride and vinylidene chloride), acrylates (e.g., methyl acrylate, ethyl acrylate and 2-ethylhexyl acrylate), methacrylates (e.g., methyl methacrylate, ethyl methacrylate, butyl methacrylate and ethylene glycol dimethacrylate), styrene derivatives (e.g., styrene, divinylbenzene, vinyltoluene and α-methylstyrene), vinyl ethers (e.g., methyl vinyl ether, ethyl vinyl ether and cyclohexyl vinyl ether), vinyl esters (e.g., vinyl acetate, vinyl propionate and vinyl cinnamate), acrylamides (e.g., N-tert-butylacrylamide and N-cyclohexylacrylamide), methacrylamides and acrylonitrile derivatives. Curing agents may properly be used in combination with the above-mentioned polymers as described in JP-A-10-25388 and JP-A-10-147739.

### (Light-Scattering Layer)

A light-scattering layer is formed for the purpose of imparting to the film light-diffusing properties based on surface scattering and/or internal scattering and hard coat properties for improving scratch resistance of the film. Therefore, a formed light-scattering layer contains a binder for imparting hard coat properties, matt particles for imparting light-scattering properties and, as needed, inorganic fillers for increasing refractive index, preventing shrinkage due to cross-linking and enhancing strength. In view of imparting hard coat properties and suppressing generation of curl and deterioration of anti-fragile properties, the thickness of the light-scattering layer is preferably from 1 μm to 10 μm, more preferably from 1.2 μm to 6 μm.

The binder for the light-scattering layer is preferably a polymer which contains a saturated hydrocarbon chain or a polyether chain as a main chain, more preferably a polymer which contains a saturated hydrocarbon chain as a main chain. The binder polymer preferably has a cross-linked structure. As the binder polymer which contains a saturated hydrocarbon chain as a main chain, a polymer of an ethylenically unsaturated monomer is preferred. As the binder polymer which contains a saturated hydrocarbon chain as a main chain and has a cross-linked structure, a (co)polymer of a monomer having two or more ethylenically unsaturated groups is preferred. In order to increase the refractive index of the binder polymer, it is also possible to select, as a member of the polymer-constituting monomers, monomers containing in the monomer structure an aromatic ring or at least one atom selected from among halogen atoms other than fluorine atom, sulfur atom, phosphorus atom and nitrogen atom.

Examples of the monomer having two or more ethylenically unsaturated groups include esters between a polyhydric alcohol and (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate), ethylene oxide-modified products thereof, vinylbenzene and the derivatives thereof (e.g., 1,4-divinylbenzene, 2-acryloylethyl 4-vinylbenzoate and 1,4-divinylcyclohexanone), vinylsulfones (e.g., divinylsulfone), acrylamides (e.g., methylenebisacrylamide) and methacrylamides. These monomers may be used in combination of two or more thereof.

Specific examples of the monomers having a high refractive index include bis(4-methacryloylthiophenyl)sulfide, vinylnaphthalene, vinylphenylsulfide, 4-methacryloxyphenyl-4′-methoxyphenylthioether, etc. These monomers also may be used in combination of two or more thereof.

Polymerization of the monomers having an ethylenically unsaturated group can be performed by irradiating with ionization radiation or by heating in the presence of a photo radical initiator or a thermal radical initiator.

Therefore, the anti-reflection layer can be formed by preparing a coating solution containing a monomer having an ethylenically unsaturated group, a photo radical initiator or a thermal radical initiator, matt particles and an inorganic filler, coating the coating solution on a transparent support and curing the solution by polymerization reaction caused by ionization radiation or heat. As the photo radical initiator or the like, known ones can be used.

The polymer having a polyether as a main chain is preferably a ring-opening polymerization product of a multi-functional epoxy compound. Ring-opening polymerization of the multi-functional epoxy compound can be conducted by irradiation with ionization radiation or by heating in the presence of a photo acid generator or a thermal acid generator.

Accordingly, the anti-reflection layer can be formed by preparing a coating solution containing a multi-functional epoxy compound, a photo acid generator or a thermal acid generator, matt particles and an inorganic filler, coating the coating solution on a transparent support and curing the solution by polymerization reaction caused by ionization radiation or heat.

A cross-linkable group may be introduced into the polymer by using a monomer having a cross-linkable group in place of, or in addition to, the monomer having two or more ethylenically unsaturated groups, and a cross-linked structure may be introduced into the binder polymer by the reaction of the cross-linkable group.

Examples of the cross-linkable group include an isocyanato group, an epoxy group, an aziridine group, an oxazoline group, an aldehydro group, a carbonyl group, a hydrazine group, a carboxyl group, a methylol group and an active methylene group. Vinylsulfonic acids, acid anhydrides, cyanoacrylate derivatives, melamine, etherified methylols, esters, urethanes and metal alkoxides such as tetramethoxysilane can also be utilized as monomers for introducing the cross-linked structure. A functional group which shows cross-linking properties as a result of decomposition reaction such as a blocked isocyanato group may be used as well. That is, in the invention, the cross-linkable functional group may be a group which does not show reactivity as such but shows reactivity as a result of decomposition thereof.

The binder polymer having the cross-linkable functional group can form a cross-linked structure upon being heated after coating.

The light-scattering layer preferably contains matt particles larger than filler particles, having an average particle size of from 1 μm to 10 μm, preferably from 1.5 μm to 7.0 μm, such as particles of an inorganic compound or resin particles for the purpose of showing anti-glare properties.

As specific examples of the matt particles, there are preferably illustrated, for example, particles of inorganic compounds such as silica particles and TiO₂ particles; and rein particles such as acrylic particles, cross-linked acrylic particles, polystyrene particles, cross-linked styrene particles, melamine resin particles and benzoguanamine resin particles. Of these, cross-linked styrene particles, cross-linked acrylic particles, cross-linked acrylstyrene particles and silica particles are preferred. As to shape of matt particles, either of spherical particles and amorphous particles may be used.

Two or more kinds of matt particles different in particle size may be used. It is possible to impart anti-glare properties by matt particles having a larger particle size and other optical properties by matt particles having a smaller particle size.

Further, as to particle size distribution of the matt particles, a monodisperse system is most preferred, and, the nearer the particle sizes of individual particles to one and the same particle size, the more preferred. For example, when particles having a particle size larger than the average particle size by 20% are defined as coarse particles, the proportion of the coarse particles is preferably 1% or less, more preferably 0.1% or less, still more preferably 0.01% or less, based on the population of the total particles. Matt particles having such particle size distribution can be obtained by classification after ordinary synthesis reaction, and matt particles having a more preferred particle size distribution can be obtained by increasing the number of classification procedure or strengthening the classification degree.

The matt particles are incorporated in the light-scattering layer in an amount so that the amount of the matt particles in the formed light-scattering layer becomes preferably from 10 mg/m² to 1000 mg/m², more preferably from 100 mg/m² to 700 mg/m². The particle size distribution of matt particles is measured according to the Coulter counter method, and the measured distribution is converted to particle number distribution.

In order to increase the refractive index of the light-scattering layer, it is preferred to incorporate inorganic fillers of 0.2 μm or less, preferably 0.1 μm or less, more preferably 0.06 μm or less, in average particle size which comprise an oxide of at least one metal selected from among titanium, zirconium, aluminum, indium, zinc, tin and antimony, in addition to the matt particles.

On the other hand, in order to enlarge the refractive index gap between the inorganic fillers and the matt particles, it is also preferred to use a silicon oxide for keeping at a low level the refractive index of the light-scattering layer using the matt particles having a high refractive index. As to preferred particle size of the silicon oxide, the particle size described with respect to the inorganic fillers applies.

Specific examples of the inorganic fillers to be used in the light-scattering layer include TiO₂, ZrO₂, Al₂O₃, In₂O₃, ZnO, SnO₂, Sb₂O₃, ITO and SiO₂, with TiO₂ and ZrO₂ being particularly preferred in view of increasing the refractive index. It is also preferred to subject the surface of the inorganic fillers to silane coupling treatment or titanium coupling treatment. A surface treating agent having a functional group capable of reacting with the binder species is preferably applied to the filler surface. The addition amount of the inorganic fillers is preferably from 10 to 90% by mass, more preferably from 20 to 80% by mass, particularly preferably from 30 to 75% by mass, based on the total mass of the light-scattering layer. Additionally, such fillers have a particle size enough smaller than the wavelength of light not to cause scattering, and a dispersion body wherein the fillers are dispersed in a binder polymer acts as an optically uniform substance.

The refractive index of the balk of a mixture of the binder and the inorganic filler for the light-scattering layer is preferably from 1.48 to 2.00, more preferably from 1.50 to 2.00, still more preferably from 1.50 to 1.80. In order to adjust the refractive index to the range, it suffices to properly select kinds and amounts of the binder and the inorganic filler. Which ones to select can be easily known through previous experiments.

With the light-scattering layer, it is preferred to incorporate either or both of a fluorine-containing surfactant and a silicone surfactant in a coating composition for forming an anti-glare layer in order to ensure surface uniformity free of coating unevenness, drying unevenness and spot defects. In particular, the fluorine-containing surfactant is preferably used because it can provide the effect of removing surface troubles such as coating unevenness, drying unevenness and spot defects. The surfactants are used for the purpose of enhancing productivity by imparting adaptability for high-speed coating while improving surface uniformity.

Next, an anti-reflection layer wherein a middle refractive index layer, a high refractive index layer and a low refractive index layer are laminated in this order and which is provided on the transparent protective film will be described below.

An anti-reflection layer comprising a layer structure of at least a middle refractive index layer, a high refractive index layer and a low refractive index layer (outermost layer) in this order on a substrate is preferably designed so as to have refractive indexes satisfying the following relations: refractive index of high refractive index layer>refractive index of middle refractive index layer>refractive index of low refractive index layer.

Also, a hard coat layer may be provided between the transparent support and the middle refractive index layer. Further, the anti-reflection layer ma comprise a middle refractive index hard coat layer, a high refractive index layer and a low refractive index layer (see, for example, JP-A-8-122504, JP-A-8-110401, JP-A-10-300902, JP-A-2002-243906 and JP-A-2000-111706). Each layer may have other functions. For example, there are illustrated a stain-proof low refractive index layer and an antistatic high refractive index layer (described in, for example, JP-A-10-206603 and JP-A-2002-243906).

The haze of the anti-reflection layer is preferably 5% or less, more preferably 3% or less. Also, the strength of the film is preferably H or more, more preferably 2H or more, most preferably 3H or more, by the pencil hardness test according to JIS K5400.

### (High Refractive Index Layer and Middle Refractive Index Layer)

The layer with a high refractive index in the anti-reflection layer preferably comprises a curable film containing at least ultra-fine particles of an inorganic compound of 100 nm or less in average particle size having a high refractive index and a matrix binder.

As the fine particles of an inorganic compound having a high refractive index, there are illustrated inorganic compounds having a refractive index of 1.65 or more, preferably 1.9 or more. Examples thereof include oxides of Ti, Zn, Sb, Sn, Zr, Ce, Ta, La and In and composite oxides containing these metal atoms.

In order to prepare the super-fine particles, there are illustrated a method of treating the particle surface with a surface-treating agent (for example, silane coupling agents described in JP-A-11-295503, JP-A-11-153703 and JP-A-2000-9908; anionic compounds or organometallic coupling agents described in JP-A-2001-310432), a method of forming a core-shell structure wherein high refractive index particles constitute cores (described in, for example, JP-A-2001-166104 and JP-A-2001-310432) and a method of using a specific dispersing agent in combination with the particles (described in, for example, JP-A-11-153703, U.S. Pat. No. 6,210,858 and JP-A-2002-2776069).

As materials for forming the matrix, there are illustrated conventionally known thermoplastic resins and curable resin films.

Further, at least one composition selected from a composition containing a multi-functional compound having at least two radical-polymerizable and/or cation-polymerizable groups and a composition containing an organometallic compound having a hydrolysable group and a partial condensate thereof is preferred. For example, there are illustrated those compositions which are described in JP-A-2000-47004, JP-A-2001-315242, JP-A-2001-31871 and JP-A-2001-296401.

Also, a curable film obtained from a colloidal metal oxide obtained from a hydrolytic condensate of a metal alkoxide and a metal alkoxide composition, which is described in, for example, JP-A-2001-293818, is preferred.

The refractive index of the high refractive index layer is generally from 1.70 to 2.20. The thickness of the high refractive index layer is preferably from 5 nm to 10 μm, more preferably from 10 nm to 1 μm. The refractive index of the middle refractive index layer is adjusted so that it falls between the refractive index of the low refractive index layer and the refractive index of the high refractive index layer. The refractive index of the middle refractive index layer is preferably from 1.50 to 1.70. The thickness of the middle refractive index layer is preferably from 5 nm to 10 μm, preferably from 10 nm to 1 μm.

### (Low Refractive Index Layer)

The low refractive index layer is laminated on the high refractive index layer. The refractive index of the low refractive index layer is preferably from 1.20 to 1.55, more preferably from 1.30 to 1.50.

It is preferred to constitute the low refractive index layer as an outermost layer having scratch-resistant properties and stain-proof properties. As means for largely improving scratch resistance, it is effective to impart slipping properties to the surface, and a method of forming a thin layer by introducing silicone or fluorine, which is conventionally known, can be employed.

The refractive index of the fluorine-containing compound is preferably from 1.35 to 1.50, more preferably from 1.36 to 1.47. Also, the fluorine-containing compound is preferably a compound which contains fluorine atom in a content of from 35 to 80% by mass and has a cross-linkable or polymerizable functional group. Examples thereof include compounds described in JP-A-9-222503, paragraphs [0018] to [0026], JP-A-11-38202, paragraphs [0019] to [0030], JP-A-2001-40284, paragraphs [0027] to [0028], and JP-A-2000-284102.

The silicone compound is a compound having a polysiloxane structure, and those compounds which contain a curable functional group or a polymerizable functional group in the high molecular chain and form a cross-linked structure in the film are preferred. For example, there are illustrated reactive silicones (e.g., SILAPLANE (manufactured by Chisso Corporation) and polysiloxanes having a silanol group on each end (described in JP-A-11-258403).

Cross-linking or polymerization reaction of the fluorine-containing and/or siloxane polymer having a cross-linkable or polymerizable group is preferably performed by irradiation with light or by heating simultaneously with, or after, coating of a coating composition for forming the outermost layer containing a polymerization initiator and a sensitizing agent.

A sol-gel cured film formed by condensation reaction between an organometallic compound such as a silane coupling agent and a silane coupling agent containing a specific fluorine-containing hydrocarbon group in the co-presence of a catalyst is also preferred.

For example, there are illustrated polyfluoroalkyl group-containing silane compounds or the partially hydrolytic condensates thereof (compounds described in, for example, JP-A-58-142958, JP-A-58-147483, JP-A-58-147484, JP-A-9-157582 and JP-A-11-106704) and silyl compounds containing a fluorine-containing long chain group of a poly “perfluoroalkyl ether” group (compounds described in JP-A-2000-117902, JP-A-2001-48590 and JP-A-2002-53804).

The low refractive index layer can contain, in addition to the above-mentioned additives, fillers (e.g., low refractive index inorganic compounds of from 1 nm to 150 nm in primary average particle size such as silicon dioxide (silica) and fluorine-containing particles (e.g., magnesium fluoride, calcium fluoride and barium fluoride) and organic fine particles described in JP-A-11-3820, paragraphs [0020] to [0038]), silane coupling agents, slipping agents and surfactants.

In the case where the low refractive index layer is positioned under the outermost layer, the low refractive index layer may be formed by a gas-phase method (e.g., a vacuum deposition method, a sputtering method, an ion-plating method or a plasma CVD method). In view of inexpensive production cost, the coating method is preferred. The thickness of the low refractive index layer is preferably from 30 nm to 200 nm, more preferably from 50 m to 150 nm, most preferably from 60 nm to 120 nm.

### (Other Layers in the Anti-Reflection Film)

Further, a hard coat layer, a forward scattering layer, a primer layer, an antistatic layer, an undercoat layer and a protective layer may be provided.

### (Hard Coat Layer)

A hard coat layer is provided on the surface of the transparent support in order to impart physical strength to the transparent protective film on which the anti-reflection layer is provided. The hard coat layer is particularly preferably between the transparent support and the high refractive index layer. The hard coat layer is preferably formed by cross-linking reaction or polymerization reaction of a photo- and/or heat-curable compound. As a curable functional group, a photo-polymerizable functional group is preferred and, as an organometallic compound containing a hydrolysable functional group, an organic alkoxysilyl compound is preferred.

As specific examples of these compounds, there are those compounds which have been illustrated with respect to the high refractive index layer. As a specific constitutional composition for the hard coat layer, there are illustrated, for example, those which are described in JP-A-2002-144913, JP-A-2000-9908 and WO00/46617.

The high refractive index layer can also function as the hard coat layer. In such case, it is preferred to finely disperse fine particles by employing the method described with respect to the high refractive index layer and incorporating them in the hard coat layer to thereby form such highly refractive index layer.

The hard coat layer can also function as an anti-glare layer having anti-glare function by incorporating therein particles of from 0.2 μm to 10 μm.

The thickness of the hard coat layer can adequately be designed according to use. The thickness of the hard coat layer is preferably from 0.2 μm to 10 μm, more preferably from 0.5 μm to 7 μm.

The strength of the hard coat layer is preferably H or more, more preferably 2H or more, most preferably 3H or more, by the pencil hardness test according to JIS K5400. Also, in the Taber test according to JIS K5400, samples showing a less abrasion amount after the test are more preferred.

### (Antistatic Layer)

In the case of providing an antistatic layer, it is preferred to impart electrical conductivity of 10⁻⁸ Ωcm⁻³ in volume resistivity. It is possible to impart a volume resistivity of 10⁻⁸ Ωcm⁻³ by using a hygroscopic substance, a water-soluble inorganic salt, a certain kind of surfactant, a cation polymer, an anion polymer or colloidal silica. However, such conductivity is so dependent upon temperature and humidity that there is involved a problem that a sufficient electrical conductivity can not be obtained at a low humidity. Therefore, metal oxides are preferred as materials for the antistatic layer. Some of the metal oxides are colored and, when used as materials for the antistatic layer, they color the whole film, thus not being preferred Examples of metals forming colorless metal oxides include Zn, Ti, Al, In, Si, Mg, Ba, Mo, W and V. It is preferred to use metal oxides containing them as a major component. As specific examples thereof, ZnO, TiO₂, SnO₂, Al₂O₃, In₂O₃, SiO₂, MgO, BaO, MoO₃, V₂O₅ and the composite oxides thereof are preferred, with ZnO, TiO₂ and SnO₂ being particularly preferred. With examples of containing different kind of atom, addition of Al or In is effective for ZnO, addition of Sb, Nb or a halogen element is effective for SnO₂, and addition of Nb or Ta is effective for TiO₂. Further, as is described in JP-B-59-6235, materials comprising other crystalline metal particles or fibrous materials (e.g., titanium oxide) having deposited thereon the above-mentioned metal oxides may be used. Additionally, though volume resistivity and surface resistivity are different physical properties and can not simply be compared with each other, it suffices for the antistatic layer to have a surface resistivity of about 10⁻¹⁰Ω/□ or less, more preferably 10⁻⁸Ω/□ in order to ensure an electrical conductivity of 10⁻⁸ Ωcm⁻³ or less in volume resistivity. The surface resistivity of the antistatic layer must be measured as a value of a film having the antistatic layer as the outermost layer, and can be measured in the course of the process of forming the laminate film described in this specification.

Next, a liquid crystal display device of the invention characterized by having at least one of the cyclic polyolefin film, the protective film for a polarizing plate, the optically-compensatory film and the polarizing plate will be described below.

### (Liquid Crystal Display Device)

The cyclic polyolefin film of the invention, an optically-compensatory film having the film and a polarizing plate using the film can be used in various-mode liquid crystal cells and liquid crystal display devices. There have been proposed various display modes such as TN (Twisted Nematic) mode, IPS (In-Plane Switching) mode, FLC (Ferroelectric Liquid Crystal) mode, AFLC (Anti-Ferroelectric Liquid Crystal) mode, OCB (Optically-Compensatory Bend) mode, STN (Super Twisted Nematic) mode, VA (Vertically Alighed) mode, HAN (Hybrid Aligned Nematic) mode and ECB (Electrically Controlled Birefringence) mode. Of these, IPS mode, ECB mode and VA mode are modes wherein they can preferably be used.

### (IPS-Mode Liquid Crystal Display Device and ECB-Mode Liquid Crystal Display Device)

The Cyclic Polyolefin Film of the Invention can Also be Used with Particular advantages as a support for an optically-compensatory sheet or a protective film for a polarizing plate in an IPS-mode liquid crystal display device and an ECB-mode liquid crystal display device having an IPS-mode liquid crystal cell and an ECB-mode liquid crystal cell, respectively. These modes are modes wherein a liquid crystal material is aligned approximately in parallel upon black display and wherein liquid crystal molecules are aligned in parallel to the substrate plane to give black display when no voltage is applied thereto. In these embodiments, a polarizing plate using the cyclic polyolefin film of the invention serves to enlarge a viewing angle and improve contrast.

### (OCB-Mode Liquid Crystal Display Device)

The liquid crystal cell of OCB mode is a liquid crystal cell of bend alignment mode in which rod-like liquid crystal molecules in upper part and ones in lower part are substantially reversely (symmetrically) aligned. An OCB-mode liquid crystal cell is disclosed in U.S. Pat. Nos. 4,583,825 and 5,410,422. Since rod-like liquid crystal molecules in upper part and ones in lower part are symmetrically aligned, the liquid crystal cell of bend alignment mode has self-optically-compensatory function. Therefore, this liquid crystal mode is also referred to as OCB (Optically Compensatory Bend) mode. The liquid crystal display of bend alignment mode has an advantage of responding rapidly.

### (VA Mode Liquid Crystal Display Device)

In a VA mode liquid crystal cell, rod-like liquid crystal molecules are substantially vertically aligned when no voltage is applied thereto.

VA mode liquid crystal cells include:

(1) a VA mode liquid crystal cell in the narrow sense (JP-A-2-176625) wherein rod-like liquid crystal molecules are aligned substantially vertically while voltage is not applied, and the molecules are aligned substantially horizontally while voltage is applied;
(2) a liquid crystal cell (of MVA mode) (described in SID97, Digest of tech. Papers, (Yokoshu), 28 (1997)845, in which the VA mode is modified to be multi-domain type so as to enlarge the viewing angle;
(3) a liquid crystal cell of a mode (n-ASM mode) (described in Nihon Ekisho Toronkai no Yokoshu (Abstracts of Japanese Forum of Liquid Crystal), (1998), pp. 58 to 59, in which rod-like liquid crystal molecules are substantially vertically aligned while voltage is not applied, and the molecules are substantially oriented in twisted multi-domain alignment while voltage is applied; and
(4) a cell of SURVAIVAL mode (presented in LCD Internatianal '98).

The VA mode liquid crystal display device comprises a liquid crystal cell having provided on each side thereof a polarizing plate. The liquid crystal cell carries a liquid crystal between two electrode substrates. In one embodiment of the invention of a transmission type liquid crystal display device, one of the optically-compensatory films of the invention is provided between the liquid crystal cell and one polarizing plate, or two of the optically-compensatory films are respectively provided between the liquid crystal cell and one polarizing plate and between the liquid crystal cell and the other polarizing plate.

In another embodiment of the transmission type liquid crystal display device of the invention, an optically-compensatory film having the cyclic polyolefin film of the invention is used as a transparent protective film for a polarizing plate disposed between a liquid crystal cell and a polarizer. That is, the transparent protective film for the polarizing plate also functions as an optically-compensatory film. The optically-compensatory film may be used as a transparent protective film for only one of the polarizing plates (between the liquid crystal cell and the polarizer) or may be used as two transparent protective films for two polarizing plates (between the liquid crystal cell and each polarizer). In the case of using the optically-compensatory film for only one polarizing plate, it is particularly preferred to use it as a protective film on the liquid cell side of a polarizing plate on the backlight side of the liquid cell. The film is preferably stuck onto the liquid crystal cell with the cyclic polyolefin film of the invention being on the VA cell side. Another protective film may be a commonly used cellulose acylate film. The thickness is preferably from 40 μm to 80 μm, and examples thereof include commercially available KC4UX2M (manufactured by Konica Opto Co., Ltd.; 40 μm), KC5UX (manufactured by Konica Opto Co., Ltd.; 60 μm) and TD80 (manufactured by Fuji Photo Film Co., Ltd.; 80 μm) which, however, are not limitative at all.

With an OCB-mode liquid crystal display device or a TN-mode liquid crystal display device, an optically-compensatory film is used for enlarging the viewing angle. As the optically-compensatory film for an OCB cell, an optically-compensatory film is used which is obtained by providing, on an optically uniaxial or biaxial film, an optically anisotropic layer wherein a discotic liquid crystal is hybrid-aligned and fixed. As the optically-compensatory film for a TN cell, an optically-compensatory film is used which is obtained by providing, on a film having optical isotropy or having an optical axis in a thickness-direction, an optically anisotropic layer wherein a discotic liquid crystal is hybrid-aligned and fixed. The cyclic polyolefin film of the invention is also useful for preparing the optically-compensatory film for an OCB cell or a TN cell.

### EXAMPLES

The invention will be specifically described based on Examples which, however, do not limit the invention in any way.

### [Evaluation of Physical Properties of the Cyclic Polyolefin Film]

Various properties of the film were evaluated by measuring in the following manner.

### <Retardation>

Retardation was measured by means of KOBRA 21ADH (manufactured by Ohji Measurement Co., Ltd.).

### <Haze of the Film>

The haze of the cyclic polyolefin film of the invention is preferably from 0.01 to 2.0%, more preferably from 0.05 to 1.5%, still more preferably from 0.1 to 1.0%. Transparency of the film is of importance as an optical film. Measurement of haze was conducted by preparing a 40 mm×80 mm sample of the cyclic polyolefin film of the invention and using a haze meter (HGM-2DP; manufactured by Suga Test Instruments Co., Ltd.) at 25° C. and 60% RH according to JIS K-6714

### [Synthesis of the Cyclic Polyolefin Resin and Additives]

### <Synthesis of Cyclic Polyolefin Polymer P-1>

100 Parts by mass of purified toluene and 100 parts by mass of methyl norbornenecarboxylate were introduced into a reactor. Subsequently, 25 mmol % (based on the mass of the monomer) of Ni-ethylhexanoate dissolved in toluene, 0.225 mol % (based on the mass of the monomer) of tri(pentafluorophenyl)boron and 0.25 mol (based on the mass of the monomer) of triethylaluminum dissolved in toluene were introduced into the reactor. The mixture was stirred for 18 hours at room temperature to react. After completion of the reaction, the reaction mixture was introduced into excess ethanol to form a polymer precipitate. The precipitate was purified, and the thus-obtained cyclic polyolefin polymer (PF-1) was dried at 65° C. for 24 hours in vacuo.

The resulting polymer was dissolved in tetrahydrofuran and was subjected to gel permeation chromatograph to measure the molecular mass thereof. Thus, the number-average molecular mass and the mass-average molecular mass of the polymer in terms of polystyrene were found to be 79,000 and 205,000, respectively. The refractive index of the resulting polymer measured by Abbe's refractometer was 1.52.

### <Synthesis of A-19>

A retardation Rth(λ) decreasing agent was prepared in the following manner. 10.92 g of benzylsulfonyl chloride and 57 ml of methylene chloride were measured and introduced into a 500-ml three neck flask equipped with a mechanical stirrer, a thermometer, a cooling tube and a dropping funnel and, after dropwise adding thereto 12.27 g of benzylamine under cooling with ice, the temperature of the reaction mixture was restored to room temperature, followed by reacting for 2 hours at room temperature. 150 ml of water was added to the reaction mixture, and the mixture was extracted with 150 ml of methylene chloride, followed by separation. The thus-obtained organic layer was washed twice with 150 ml of 1N hydrochloric acid and a saturated sodium chloride aqueous solution and, after dehydrating with anhydrous magnesium sulfate, was concentrated to obtain 13 g of a white solid. The thus-obtained white solid was re-crystallized from a mixed solution of ethyl acetate (100 ml) and hexane (100 ml). After collecting the crystals by filtration, the crystals were dried in vacuo at room temperature to obtain 8.7 g of the intended retardation Rth(λ) decreasing agent (yield: 58%).

As will be shown in Table 1 to be described hereinafter, this additive shows a larger effect of decreasing Rth in comparison with Re when added to the film, and hence, this additive can be used as a retardation Rth(λ) decreasing agent.

### <Synthesis of B-3>

Likewise, a retardation Re(λ) decreasing agent was prepared in the following manner. 12.11 g of benzylsulfonyl chloride and 38 ml of methylene chloride were measured and introduced into a 500-ml three neck flask equipped with a mechanical stirrer, a thermometer, a cooling tube and a dropping funnel and, after dropwise adding thereto 10.50 g of benzylamine under cooling with ice, the temperature of the reaction mixture was restored to room temperature, followed by reacting for 2 hours at room temperature. 200 ml of water was added to the reaction mixture, and the mixture was extracted with 200 ml of methylene chloride, followed by separation. The thus-obtained organic layer was washed twice with 200 ml of 1N hydrochloric acid and a saturated sodium chloride aqueous solution and, after dehydrating with anhydrous magnesium sulfate, was concentrated to obtain 12 g of a white solid. The thus-obtained white solid was recrystallized from a mixed solution of ethyl acetate (100 ml) and hexane (100 ml). After collecting the crystals by filtration, the crystals were dried in vacuo at room temperature to obtain 6.8 g of the intended retardation Re(λ) decreasing agent (yield: 56%).

As will be shown in Table 1 to be described hereinafter, this additive shows a larger effect of decreasing Re in comparison with Rth when added to the film, and hence, this additive can be used as a retardation Re(λ) decreasing agent.

### <Synthesis of (EA-8)>

20.2 g of sebacic acid was weighed and introduced into a 300-ml three neck flask equipped with a mechanical stirrer, a thermometer, a cooling tube and a dropping funnel and, after gradually dropwise adding thereto 47.6 g of thionyl chloride, reaction was conducted for 2 hours at 80° C. After confirming that the reaction solution became uniform, the reaction system was concentrated as such using an aspirator to distill off excess thionyl chloride and obtain an oily product. Separately, 39.9 g of dicyclohexylamine, 22.3 g of triethylamine and 200 ml of THF were measured and introduced into another 300-ml three neck flask equipped with a mechanical stirrer, a thermometer, a cooling tube and a dropping funnel, and the oily product obtained by the above-mentioned reaction was gradually dropwise added thereto. After completion of the dropwise addition, the temperature of the reaction mixture was restored to room temperature, followed by reacting for further 4 hours. The resultant reaction mixture was introduced into 1 L of water to precipitate white crystals. After collecting the crystals by filtration, the crystals were dried overnight at 50° C. to obtain 25.4 g of the end product A-8 (yield: 48%).

### <Synthesis of (EB-1)>

10.0 g of N,N′-dimethyl-1,3-diaminopropane, 20.8 g of triethylamine and 100 ml of THF were measured and introduced into a 300-ml three neck flask equipped with a mechanical stirrer, a thermometer, a cooling tube and a dropping funnel and, after gradually dropwise adding thereto 29.6 g of cyclohexanecarbonyl chloride, the temperature was restored to room temperature, followed by reacting for further 2 hours at room temperature. 200 ml of water was added to the resulting reaction mixture, and the mixture was extracted with 300 ml of ethyl acetate, followed by separation. The thus-obtained organic layer was washed, each twice, with 300 ml of 1N hydrochloric acid, 300 ml of an aqueous solution saturated with sodium bicarbonate and 200 ml of water and, after dehydrating with anhydrous magnesium sulfate, was concentrated to obtain a transparent oily product. Drying in vacuo of the resulting oily product at room temperature yielded 27.7 g of the end compound B1-1 (yield: 47%).

### Example 1

The following composition was introduced into a mixing tank and stirred to dissolve individual components, and then filtered through filter paper of 34 μm in average pore size and a sintered metal filter of 10 μm in average pore size to prepare a dope for forming a film.

| | | |
|---|---|---|
| Cyclic polyolefin polymer P-1 | 100 | parts by mass |
| Dichloromethane | 325 | parts by mass |
| Methanol | 28.3 | parts by mass |
| Compound A-19 | 15 | parts by mass |

The dope was cast by means of a band casting machine. The film released from the band at a residual solvent amount of about 30% by mass was stretched while holding by means of a tenter, and then dried by applying a 140° C. hot water. Thereafter, the tenter conveying of the film was shifted to roll conveying of the film, followed by drying the film at 120° C. to 140° C. to obtain a cyclic olefin series resin film F-3 of 1440 mm in width. The film F-3 had a thickness of 79 μm.

Re retardation and Rth retardation of the produced film were measured by means of KOBRA 21ADH (manufactured by Ohji Measurement Co., Ltd.). Optical unevenness, i.e., unevenness of Re retardation and Rth retardation, was evaluated by using the difference between the maximum value and the minimum value measured with 7 samples obtained by sampling with 20-cm intervals from a sample film of 130 cm in width.

Cyclic olefin series resin films F-1 to F-43 were obtained in the same manner as with the film F-3 except for changing the formulation of the dope for forming the film as shown in Table and changing the stretch ratio.

Additionally, in the table, Appear3000 means Appear3000 (trade name) of cyclic polyolefin resin manufactured by Ferrania, Arton means Arton G (trade name) of cyclic polyolefin resin manufactured by JSR, and ZEONOR means ZEONOR ZF14 (trade name) manufactured by ZEON CORPORATION.

7 samples were sampled from the cyclic olefin series resin film of 1440 mm in width with 20-cm intervals in the width direction. Rth of each of the 7 samples was measured by means of an automatic birefringence-measuring apparatus (KOBRA 21ADH (manufactured by Ohji Measurement Co., Ltd.) to determine the absolute value of difference between the maximum value and the minimum value.

TABLE 1

| | Film | Method for Forming | Cyclic Olefin | Amount of | | |
|---|---|---|---|---|---|---|
| | Thickness | Film | Resin | Polymer | Dichloromethane | Methanol |
| F-01 | 79 | Solution casting | P-1 | 100 | 325 | 28.5 |
| F-02 | 79 | Solution casting | P-1 | 100 | 325 | 28.5 |
| F-03 | 79 | Solution casting | P-1 | 100 | 325 | 28.3 |
| F-04 | 80 | Solution casting | P-1 | 100 | 307 | 26.6 |
| F-05 | 79 | Solution casting | P-1 | 100 | 287 | 24.6 |
| F-06 | 48 | Solution casting | P-1 | 100 | 325 | 28.3 |
| F-07 | 45 | Solution casting | P-1 | 100 | 307 | 26.6 |
| F-08 | 81 | Solution casting | P-1 | 100 | 317 | 27.6 |
| F-09 | 80 | Solution casting | P-1 | 100 | 316 | 27.5 |
| F-10 | 78 | Solution casting | P-1 | 100 | 308 | 26.8 |
| F-11 | 81 | Solution casting | P-1 | 100 | 297 | 25.6 |
| F-12 | 80 | Solution casting | P-1 | 100 | 290 | 25.2 |
| F-13 | 81 | Solution casting | P-1 | 100 | 317 | 27.6 |
| F-14 | 80 | Solution casting | P-1 | 100 | 325 | 28.3 |
| F-15 | 81 | Solution casting | P-1 | 100 | 308 | 28.5 |
| F-16 | 79 | Solution casting | P-1 | 100 | 325 | 28.3 |
| F-17 | 80 | Solution casting | P-1 | 100 | 288 | 24.7 |
| F-18 | 79 | Solution casting | P-1 | 100 | 317 | 27.6 |
| F-19 | 78 | Solution casting | P-1 | 100 | 325 | 28.3 |
| F-20 | 81 | Solution casting | P-1 | 100 | 322 | 28 |
| F-21 | 80 | Solution casting | P-1 | 100 | 317 | 27.6 |
| F-22 | 79 | Solution casting | P-1 | 100 | 312 | 27.1 |
| F-23 | 82 | Solution casting | P-1 | 100 | 292 | 25.1 |
| F-24 | 78 | Solution casting | P-1 | 100 | 325 | 28.3 |
| F-25 | 81 | Solution casting | P-1 | 100 | 322 | 28 |
| F-26 | 80 | Solution casting | P-1 | 100 | 317 | 27.6 |
| F-27 | 79 | Solution casting | P-1 | 100 | 312 | 27.1 |
| F-28 | 45 | Solution casting | P-1 | 100 | 325 | 28.3 |
| F-29 | 47 | Solution casting | P-1 | 100 | 322 | 28 |
| F-30 | 48 | Solution casting | P-1 | 100 | 317 | 27.6 |
| F-31 | 45 | Solution casting | P-1 | 100 | 312 | 27.1 |
| F-32 | 81 | Solution casting | P-1 | 100 | 317 | 27.6 |
| F-33 | 80 | Solution casting | P-1 | 100 | 317 | 27.6 |
| F-34 | 79 | Solution casting | Appear 3000 | 100 | 325 | 28.5 |
| F-35 | 80 | Solution casting | Appear 3000 | 100 | 317 | 27.6 |
| F-36 | 79 | Solution casting | Appear 3000 | 100 | 318 | 28 |
| F-37 | 78 | Solution casting | ARTON | 100 | 325 | 28.5 |
| F-38 | 81 | Solution casting | ARTON | 100 | 317 | 27.6 |
| F-39 | 80 | Solution casting | ARTON | 100 | 320 | 27.5 |
| F-40 | 80 | Melt casting | ZEONOR | 100 | 325 | 28.5 |
| F-41 | 80 | Melt casting | ZEONOR | 100 | 317 | 27.6 |
| P-42 | 76 | Melt casting | ZEONOR | 100 | 325 | 28.5 |
| F-43 | 78 | Melt casting | ZEONOR | 100 | 317 | 27.6 |

| | | | | | | | Optical |
|---|---|---|---|---|---|---|---|
| | Kind of Additive | Amount of Additive | Stretch Ratio | Re | Rth | HAZE | Unevenness |
| F-01 | None | 0 | 0 | 35 | 280 | 0.19 | 28 |
| F-02 | None | 0 | 10 | 60 | 300 | 0.2 | 12 |
| F-03 | A-19 | 15 | 10 | 58 | 220 | 0.21 | 2 |
| F-04 | A-19 | 25 | 10 | 57 | 150 | 0.29 | 2 |
| F-05 | A-19 | 46 | 10 | — | — | 7.43 | — |
| F-06 | A-19 | 15 | 10 | 38 | 152 | 0.15 | 1 |
| F-07 | A-19 | 25 | 10 | 40 | 103 | 0.17 | 1 |
| F-08 | B-3 | 10 | 10 | 10 | 270 | 0.2 | 2 |
| F-09 | B-3 | 15 | 10 | 6 | 269 | 0.2 | 2 |
| F-10 | B-3 | 20 | 10 | 0 | 268 | 0.21 | 2 |
| F-11 | B-3 | 35 | 10 | — | — | 7.21 | — |
| F-12 | B-3 | 46 | 10 | — | — | 7.3 | — |
| F-13 | A-19 &B-3 | 5, 5 | 10 | 30 | 240 | 0.21 | 2 |
| F-14 | A-19 &B-3 | 5, 10 | 10 | 28 | 208 | 0.2 | 2 |
| F-15 | A-19 &B-3 | 14, 10 | 10 | 11 | 145 | 0.19 | 2 |
| F-16 | A-19 &B-3 | 10, 5 | 10 | 10 | 238 | 0.19 | 2 |
| F-17 | A-19 &B-3 | 23, 23 | 10 | — | — | 6.85 | 2 |
| F-18 | C-11 | 10 | 10 | 48 | 230 | 0.17 | 2 |
| F-19 | D-10 | 1 | 0 | 37 | 275 | 0.2 | 10 |
| F-20 | D-10 | 5 | 0 | 36 | 221 | 0.23 | 8 |
| F-21 | D-10 | 10 | 0 | 34 | 150 | 0.25 | 8 |
| F-22 | D-10 | 15 | 0 | 27 | 118 | 0.27 | 6 |
| F-23 | D-10 | 40 | 0 | — | — | 7.55 | 14 |
| F-24 | D-10 | 1 | 10 | 56 | 298 | 0.18 | 6 |
| F-25 | D-10 | 5 | 10 | 55 | 250 | 0.19 | 4 |
| F-26 | D-10 | 10 | 10 | 52 | 190 | 0.21 | 2 |
| F-27 | D-10 | 15 | 10 | 45 | 150 | 0.25 | 2 |
| F-28 | D-10 | 1 | 10 | 42 | 202 | 0.12 | 4 |
| F-29 | D-10 | 5 | 10 | 41 | 171 | 0.15 | 2 |
| F-30 | D-10 | 10 | 10 | 37 | 129 | 0.14 | 1 |
| F-31 | D-10 | 15 | 10 | 38 | 102 | 0.18 | 1 |
| F-32 | EA-08 | 10 | 10 | 53 | 205 | 0.21 | 2 |
| F-33 | EB-1 | 10 | 10 | 62 | 215 | 0.25 | 2 |
| F-34 | None | 0 | 0 | 35 | 282 | 0.2 | 12 |
| F-35 | D-10 | 10 | 0 | 34 | 153 | 0.22 | 10 |
| F-36 | A-19 | 15 | 10 | 35 | 144 | 0.23 | 8 |
| F-37 | None | 0 | 0 | 1 | 17 | 0.18 | 12 |
| F-38 | D-10 | 10 | 0 | 0 | −30 | 0.21 | 8 |
| F-39 | A-19 | 15 | 10 | 1 | −20 | 0.2 | 6 |
| F-40 | None | 0 | 0 | 6 | 9 | 0.25 | 12 |
| F-41 | D-10 | 10 | 0 | 2 | −38 | 0.35 | 10 |
| F-42 | None | 0 | 10 | 59 | 61 | 0.3 | 6 |
| F-43 | D-10 | 10 | 10 | 55 | 20 | 0.33 | 2 |

It is seen from the results shown in Table 1 that the optical properties can be controlled with freedom not having been realized, by the combination of addition of the compounds of the invention and realization of optical properties by stretching. It is further seen that unfavorable in-plane optical unevenness which seriously appears upon stretching in the case where the compounds of the invention are not added can largely be reduced by the addition of the compounds of the invention.

### Example 2

### Preparation of Polarizing Plate A

A polarizer was prepared by adsorbing iodine on a stretched polyvinyl alcohol film. The cyclic polyolefin film (F-3) prepared in Example 1 and a cellulose ester film (T-7) of Fujitac TD80UF (manufactured by Fuji Photo Film Co., Ltd.) were subjected to glow discharge treatment (a high-frequency voltage of 3000 Hz in frequency being applied across the upper and lower electrodes for 20 seconds) to obtain protective films for a polarizing plate. The protective films were then stuck to respective sides of the polarizer using a polyvinyl alcohol series adhesive, followed by drying at 70° C. for 10 minutes. With the thus-prepared polarizing plate A, the cyclic polyolefin film PF-1 was stuck onto one side of the polarizer, and the Fujitac film T-7 was stuck onto the other side thereof in such disposition that the transmission axis of the polarizing plate was parallel to the slow axis of the Fujitac film T-7 and the transmission axis of the polarizer crossed at right angles with the slow axis of the cyclic polyolefin film PF-1.

### Example 3

### Preparation of Polarizing Plate B

Polarizing plate B was prepared in the same manner as in Example 2 except for using the cyclic polyolefin film (F-23) in place of the cyclic polyolefin film (F-3) used in Example 2.

### Comparative Example 1

### Preparation of Polarizing Plate C

Fujitac film F-7 was stuck onto each side of the polarizer prepared in Example 2. With the thus-prepared polarizing plate C, the films were disposed so that the transmission axis of the polarizer crossed at right angles with the slow axis of the Fujitac film.

### (Preparation of VA Mode Liquid Crystal Cell A)

A VA mode liquid crystal cell was prepared by dropwise injecting a liquid crystal material (“MLC6608” manufactured by Merck and Co., Inc.) having a negative-dielectric constant anisotropy between substrates spaced from each other with a cell gap of 3.6 μm to thereby form a liquid crystal layer between the substrates. The retardation of the liquid crystal layer (i.e., the product of the thickness d (μm) of the liquid crystal layer and the refractive index anisotropy Δn; Δn·d) was adjusted to 300 nm. Additionally, the liquid crystal material was aligned with a vertical alignment. A commercially available super-high contrast product (HLC2-5618 manufactured by SANRITZ CORPORATION) was stuck as a polarizing plate onto the upper side (viewer's side) of the vertically aligned liquid crystal cell via an adhesive. On the lower side (backlight side) of the liquid crystal cell was stuck the prepared polarizing plate A via an adhesive. The polarizing plates were disposed in a cross-Nicol position wherein the transition axis of the upper side polarizing plate was in the vertical direction, and the transmission axis of the lower side polarizing plate was in the horizontal direction.

As a result of observing the view of the thus-prepared liquid crystal display device, it was found that neutral black display was realized in both the frontal direction and the viewing angle direction. Also, as a result of measuring the viewing angle in 8 steps of from black display (L1) to white display (L8) (a range where contrast ratio is equal to or more than 10 and gradation reversal does not occur on the black side) by means of a measuring machine (EZ-Contrast 160D; manufactured by ELDIM), it was found that the viewing angle was as good as 80 degrees or more on both the left side and the right side.

### (Preparation of VA Mode Liquid Crystal Cells B and C)

VA mode liquid crystal cells B and C were prepared by sticking the polarizing plates B and C, respectively, in place of the polarizing plate A in the VA mode liquid crystal cell A. As a result of observing the view of the thus-prepared liquid crystal display devices, it was found that neutral black display was realized with the display device using the VA mode liquid crystal cell B in both the frontal direction and the viewing angle direction. Also, as a result of measuring the viewing angle in 8 steps of from black display (L1) to white display (L8) (a range where contrast ratio is equal to or more than 10 and gradation reversal does not occur on the black side) by means of a measuring machine (EZ-Contrast 160D; manufactured by ELDIM), it was found that the viewing angle was as good as 80 degrees or more on both the left side and the right side.

However, with the display device using the VA mode liquid crystal cell C, change in color tint was observed due to unevenness of optical properties of the film was observed in the frontal direction and the viewing angle direction. Also, it was confirmed by measurement using EZ-Contrast 160D that gradation reversal occurred at an angle of 65 degrees on the left side and 65 degrees on the right side.

### INDUSTRIAL APPLICABILITY

A cyclic polyolefin film which permits independent and simultaneous control of Re(λ) and Rth(λ) as intended and permits accurately control these optical properties and which is excellent in hygroscopicity and moisture permeability, undergoes less change in optical properties by change in temperature and humidity, has excellent handling properties and generates less optical unevenness can be provided by the practice of the invention.

Therefore, a polarizing plate or a liquid crystal display device excellent in optical properties can be provided by using this cyclic polyolefin resin film.

The entire disclosure of each and every foreign patent application from which the benefit of foreign priority has been claimed in the present application is incorporated herein by reference, as if fully set forth.

1. A cyclic polyolefin film, which comprises:
a cyclic polyolefin resin; and
at least one organic compound decreasing Rth(O), wherein Rth(λ) represents a retardation value (nm) in a thickness-direction of the cyclic polyolefin film at a wavelength of λ nm,
wherein the cyclic polyolefin film comprises the at least one organic compound in a content of from 0.01 to 30% by mass based on a solid component of the cyclic polyolefin resin.

2. A cyclic polyolefin film, which comprises:
a cyclic polyolefin resin; and
at least one organic compound decreasing Re(λ), wherein Re(λ) represents an in-plane retardation value (nm) of the cyclic polyolefin film at a wavelength of λ nm,
wherein the cyclic polyolefin film comprises the at least one organic compound in a content of from 0.01 to 30% by mass based on a solid component of the cyclic polyolefin resin.

3. A cyclic polyolefin film, which comprises:
a cyclic polyolefin resin; at least one organic compound decreasing Rth(λ), wherein Rth(λ) represents a retardation value (nm) in a thickness-direction of the cyclic polyolefin film at a wavelength of λ nm; and
at least one organic compound decreasing Re(λ), wherein Re(λ) represents an in-plane retardation value (nm) of the cyclic polyolefin film at a wavelength of λ nm,
wherein the cyclic polyolefin film comprises at least one organic compound decreasing Rth(λ) and at least one organic compound decreasing Re(λ) in a content of from 0.01 to 30% by mass based on a solid component of the cyclic polyolefin resin, respectively.

4. The cyclic polyolefin film according to claim 1, which comprises at least one compound represented by formula (1) or (2) in a content of from 0.01 to 30% by mass based on the solid component of the cyclic polyolefin resin: formula (1) 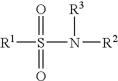
wherein R¹ represents an alkyl group or an aryl group;
R² and R³ each independently represents a hydrogen atom, an alkyl group or an aryl group, and a sum of carbon atoms of R¹, R² and R³ is 10 or more; and formula (2) 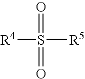
wherein R⁴ and R⁵ each independently represents an alkyl group or an aryl group, and a sum of carbon atoms of R⁴ and R⁵ is 10 or more.

5. The cyclic polyolefin film according to claim 1, which comprises at least one compound represented by formula (3), (4) or (5) in a content of from 0.01 to 30% by mass based on the solid component of the cyclic polyolefin resin: formula (3) 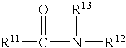
wherein R¹¹ represents an aryl group;
R¹² and R¹³ each independently represents an alkyl group or an aryl group, and at least one of R¹² and R¹³ is an aryl group; and the alkyl group and the aryl group each optionally has a substituent; formula (4) 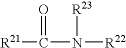
wherein R²¹, R²² and R²³ each independently represents an alkyl group which may have a substituent; and formula (5) 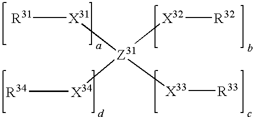
wherein R³¹, R³², R³³ and R³⁴ each independently represents a hydrogen atom, a substituted or unsubstituted aliphatic group or a substituted or unsubstituted aromatic group;
X³¹, X³², X³³ and X³⁴ each independently represents a divalent linking group formed by at least one member selected from the group consisting of a single bond, —CO—and —NR³⁵—, wherein R³⁵ represents a substituted or unsubstituted aliphatic group or a substituted or unsubstituted aromatic group; a, b, c and d each independently represents an integer of 0 or more, and a+b+c+d is 2 or more; and
Z³¹ represents an organic group having a valency of (a+b+c+d) excluding a cyclic group.

6. The cyclic polyolefin film according to claim 1, which has a thickness of at least 30 μm.

7. A process for producing a cyclic polyolefin film, which comprises: dissolving a cyclic polyolefin film according to claim 1 in an organic solvent to prepare a dope; casting the dope in a film form onto a support, so as to form a cast film; releasing the cast film from the support, so as to form a released film; and drying the released film, in this order, wherein the process further comprises: stretching the film before, during or after drying; and winding up the film.

8. A polarizing plate, which comprises:
two protective films; and
a polarizer provided between the two protective films, wherein at least one of the two protective films is a cyclic polyolefin film according to claim 1.

9. A VA mode liquid crystal display device, which comprises:
two polarizing plates; and
a liquid crystal cell provided between the two polarizing plates, wherein at lease one of the two polarizing plates is a polarizing plate according to claim 8.

10. The VA mode liquid crystal display device according to claim 9, wherein the polarizing plate according to claim 8 is used on a backlight side.
